(19) United States
(12) Patent Application Publication
(10) Pub. No.: US 2025/0304750 A1
(43) Pub. Date: Oct. 2, 2025

(54) SYNTHESIS AND RING-OPENING METATHESIS POLYMERIZATION OF A STRAINED TRANS-SILACYCLOHEPTENE AND SINGLE-MOLECULE MECHANICS OF ITS POLYMER

(71) Applicants: The Johns Hopkins University, Baltimore, MD (US); Duke University, Durham, NC (US); Massachusetts Institute of Technology, Cambridge, MA (US)

(72) Inventors: Rebekka KLAUSEN, Washington, DC (US); Sophia MELVIN, Baltimore, MD (US); Herbert S. WAKEFIELD, Baltimore, MD (US); Stephen CRAIG, Durham, NC (US); Heather KULIK, Cambridge, MA (US); Ilia KEVLISHVILI, Cambridge, MA (US)

(21) Appl. No.: 19/093,714

(22) Filed: Mar. 28, 2025

Related U.S. Application Data
(60) Provisional application No. 63/571,231, filed on Mar. 28, 2024.

(51) Int. Cl. C08G 77/60; C07F 7/08; C08G 77/00

(52) U.S. Cl. CPC C08G 77/60; C07F 7/0801; C07F 7/0807; C08G 77/80

(57) ABSTRACT

Methods of preparing trans-silacycloheptenes and their use in preparing polymers thereof under ring-opening metathesis polymerization (ROMP) conditions are disclosed. Also disclosed are methods for preparing oligosilane diene monomers and their use in preparing unsaturated poly(carbooligosilane)s via acyclic diene metathesis polycondensation. The alkene moieties of the unsaturated poly(carbooligosilane)s can be converted to epoxides via post-polymerization epoxidation.

### CROSS-REFERENCE TO RELATED APPLICATIONS

This application claims the benefit of U.S. Provisional Application No. 63/571,231, filed Mar. 28, 2024, which is incorporated herein by reference in its entirety.

### FEDERALLY SPONSORED RESEARCH OR DEVELOPMENT

This invention was made with government support under grant CHE-2116298 awarded by the National Science Foundation. The government has certain rights in the invention

### BACKGROUND

The low-strain monomers cis-cyclopentene, Neary and Kennemur, 2019, and cis-cycloheptene (cis-CH), Hejl et al., 2005, polymerize under entropy-driven ring-opening metathesis polymerization (ROMP) conditions, including high concentration and higher temperatures. Hlil et al., 2017; Pearce et al., 2019. While small- to medium-size trans-cycloalkenes are more strained than their cis-isomers, Barrows and Eberlein, 2005, investigation of trans-cycloalkene monomers for ROMP is limited to trans-polycyclooctene (PCO) as smaller rings are thermally unstable, e.g., trans-CH isomerizes to cis-CH at −40° C. Squillacote et al., 2005. trans-Cycloalkenes can be synthetically challenging, however, as they are typically synthesized by photoisomerization of the cis isomer, Wallraff et al., 1983; Hoffmann and Inoue, 1999, and the maximum yield of the trans isomer is limited by the photostationary state. Neveself et al., 2022. Thus, there is a need for improved methods for synthesizing trans-cycloalkenes, including trans-silacycloalkenes, and their subsequent polymerization under ROMP conditions.

Further, organometallic polymers represent a compelling platform for advances in new materials due to the desirable electrical, magnetic, and optical properties that arise from the combination of both organic and metallic components. Abd-El-Aziz et al., 2002; Carraher, 1981; Vidal and Jakle, 2019; Wolf, 2006; Duan et al., 2010; Priegert et al., 2016. While polymers with a backbone composed of elements from group 14 (e.g., Si, Ge, and Sn), Caseri, 2016; Katz et al., 1998; Kumar and Leitao, 2020, absorb ultraviolet light, similar to π-conjugated organic polymers and unlike polyolefins, the number of organometallic polymers is far superseded by carbon-based polymers. This limited library of hybrid inorganic-organic polymers can be attributed to the challenges with the synthesis and comparatively fewer number of monomers. For example, chain-growth polymerizations comparable to olefin polymerization are problematic for inorganic polymers as the appropriate multiply-bonded monomers, Power, 2020; Power, 1998, are difficult to prepare, air- and water-sensitive, and often require the use of bulky ligands. Priegert et al., 2016; Manners, 1996.

### SUMMARY

In some aspects, the presently disclosed subject matter provides a compound selected from:

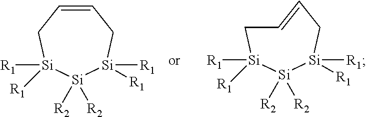

wherein: R₁ is aryl; and R₂ is C₁-C₄ alkyl.

In particular aspects, the compound is selected from:

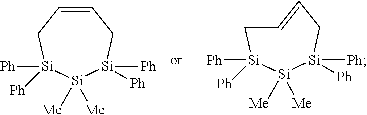

wherein: Ph is phenyl and Me is methyl.

In more particular aspects, the compound is:

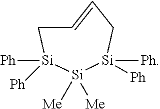 [SMILES: C[Si]1(C)[Si](c2ccccc2)(c2ccccc2)CC=CC[Si]1(c1ccccc1)c1ccccc1]

In other aspects, the presently disclosed subject matter provides a method for synthesizing the compounds referenced immediately hereinabove, the method comprising:
(a) contacting 1,1,1,3,3,3-hexamethyl-2,2-diphenyltrisilane with potassium tert-butoxide in tetrahydrofuran for a first period of time at room temperature and then adding Cl₂SiCH₃ at −78° C. for a second period of time to form 1,1,1,3,3,5,5,5-octamethyl-2,2,4,4-tetraphenylpentasilane;
(b) contacting 1,1,1,3,3,5,5,5-octamethyl-2,2,4,4-tetraphenylpentasilane with potassium tert-butoxide and 18-crown-6 in diethyl ether at room temperature for a third period of time to form a oligosilyldianion having the following chemical structure:

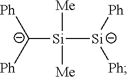 [SMILES: C[Si](C)([C-](c1ccccc1)c1ccccc1)[Si-](c1ccccc1)c1ccccc1]

(c) reacting the oligosilyldianion of step (b) with:
(i) (Z)-1,4-dichlorobutene in toluene at room temperature for a fourth period of time to form:

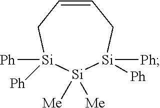 [SMILES: C[Si]1(C)[Si](c2ccccc2)(c2ccccc2)CC=CC[Si]1(c1ccccc1)c1ccccc1]

or
(ii) (E)-1,4-dichlorobutene in toluene at room temperature for a fifth period of time to form:

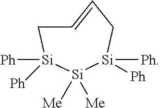 [SMILES: C[Si]1(C)[Si](c2ccccc2)(c2ccccc2)CC=CC[Si]1(c1ccccc1)c1ccccc1]

In other aspects, the presently disclosed subject matter provides a polymer having the following structure:

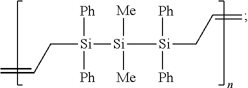

wherein n is an integer from 1 to 10,000.

In other aspects, the presently disclosed subject matter provides a method for preparing a polymer having the following structure:

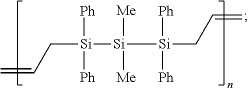

wherein n is an integer from 1 to 10,000; the method comprising:
contacting

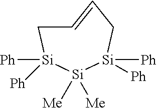 [SMILES: C[Si]1(C)[Si](c2ccccc2)(c2ccccc2)CC=CC[Si]1(c1ccccc1)c1ccccc1]

Grubbs 2nd generation catalyst in dichloromethane at room temperature for a sixth period of time.

In other aspects, the presently disclosed subject matter provides a polymer having the following structure:

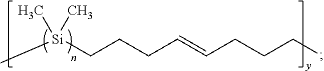

wherein: n is an integer selected from 1, 2, 3, and 4; and y is an integer from 1 to 10,000.

In other aspects, the presently disclosed subject matter provides a method for preparing a polymer having the following structure:

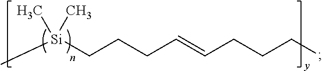

wherein: n is an integer selected from 1, 2, 3, and 4; and y is an integer from 1 to 10,000; the method comprising:
contacting

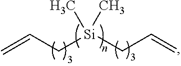

wherein n is an integer selected from 1, 2, 3, and 4, with Schrock's molybdenum catalyst (Mo═CHCMe₂Ph(═N—C₆H₃-i-Pr₂-2,6)(OCMe(CF₃)₂)₂) for a period of time to form a polymer having the following structure:

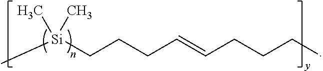

In other aspects, the presently disclosed subject matter provides a polymer having the following structure:

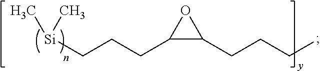

wherein: n is an integer selected from 1, 2, 3, and 4; and y is an integer from 1 to 10,000.

In other aspects, the presently disclosed subject matter provides a method for preparing a polymer having the following structure:

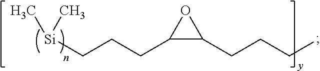

wherein: n is an integer selected from 1, 2, 3, and 4; and y is an integer from 1 to 10,000; the method comprising:
contacting

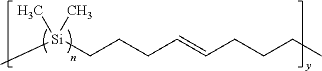

with meta-chloroperoxybenzoic acid in dichloromethane for a period of time to form a polymer having the following structure:

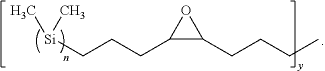

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

The patent or application file contains at least one drawing executed in color. Copies of this patent or patent application publication with color drawings will be provided by the Office upon request and payment of the necessary fee.

Having thus described the presently disclosed subject matter in general terms, reference will now be made to the accompanying Figures, which are not necessarily drawn to scale, and wherein:

FIG. 1a, FIG. 1b, and FIG. 1c show: (FIG. 1a) Si for C substitution: impact on monomer ring strain and reactivity. (FIG. 1b) Ring strain in typical Z- and E-cycloalkenes. (FIG. 1c) Silacycloheptenes for ring-opening metathesis polymerization (ROMP).

FIG. 2 is a displacement ellipsoid plot (50% probability level) of dianion 4 at 110(2) K. Hydrogens, coordinated THF solvent molecule, and disorder in 18-cr-6 omitted for clarity. Black=carbon, blue=silicon, red=oxygen, purple=potassium.

FIG. 3a, FIG. 3b, FIG. 3c, and FIG. 3d are displacement ellipsoid plots (50% probability level) of (FIG. 3a) cis- and (FIG. 3b) trans-SiCH at 110(2) K confirming geometric assignments. Newman projections along the olefinic C═C bond in (FIG. 3c) cis-SiCH and (FIG. 3d) trans-Si—CH consistent with low- and high-strain cycloalkenes. Hydrogens (except for olefinic protons) and disorder (occurring only for trans-SiCH) are omitted for clarity. Black=carbon, blue=silicon, pink=hydrogen.

FIG. 4a and FIG. 4b are: (FIG. 4a) cis-SiCH ROMP with Grubbs second-generation catalyst (G2) did not provide poly(cis-SiCH). (FIG. 4b) Superimposed cropped ¹H NMR spectra of cis-SiH (top) and after 24 h of reaction with G2 (bottom) showing unreacted monomer.

FIG. 5 is a size exclusion chromatogram ([poly(trans-SiCH)]=1 mg mL⁻¹, THF, RT) relative to polystyrene standards.

FIG. 6 shows the potential energy surface (in kcal/mol) calculated at the M06/def2-TZVPP-CPCM(DCM)//B3LYP-D4/def2-SVP level of theory for ROMP initiation. All energies refer to Gibbs free energies and are relative to I and two SiCH cycles. The trans-SiCH initiation is shown in blue, and the cis-SiCH initiation is shown in blue, with common PPh₃ ligated Ru and free Ru catalyst shown in black.

FIG. 7a, FIG. 7b, FIG. 7c, and FIG. 7d show: (FIG. 7a) Cropped ¹H NMR spectrum (benzene-d₆, 600 MHz) of poly(trans-SiCH) showing evidence of aromatic, vinylic, allylic, and methysilane resonances. (FIG. 7b)²⁹Si NMR spectrum of poly(trans-SiCH). (FIG. 7c) Cropped ¹³C NMR spectrum (benzene-d₆, 600 MHz) of poly(trans-SiCH) focusing on vinylic carbons assigned to cis- and trans-olefins. (FIG. 7d) ¹H-¹³C HSQC confirms one-bond correlation between signals assigned to olefinic resonances.

FIG. 8a and FIG. 8b show: (FIG. 8a) Thermal decomposition of poly(trans-SiCH) under a nitrogen atmosphere. (FIG. 8b) Glass-transition temperature (T_{g}) of poly(trans-SiCH) obtained by differential scanning calorimetry. The second heating cycle is shown. See FIG. 19 for full image. Heating rate: 20° C. min⁻¹, cooling rate: 10° C. min⁻¹.

FIG. 9 shows the relative force-coupled extension of fragments 5-7 calculated with the external force explicitly included (EFEI) method. The external force was applied to the endpoints of the highlighted fragments in the structures shown at right, and distances between these two atoms were normalized to their length of force-free optimized structures (i.e., L/L₀). Structures shown at right are annotated with their elasticity annotated in units of pN per unit L₀.

FIG. 10 shows representative single-molecule force-extension curves of poly(trans-SiCH, cis:trans 1:1.41), polycyclooctene (PCO, cis:trans 1:3.54), and polybutadiene (PB, cis:trans 1.70:1) normalized at 500 pN.

FIG. 11A, FIG. 11B, and FIG. 11C are schemes showing: (FIG. 11A) Ando synthesis of cis- and trans-1; (FIG. 11B) α,ω-Dipotassiooligosilyl dianions for silacycloalkene synthesis; (FIG. 11C) Synthesis of isomeric trans- and cis-SiCH; (i) KOT-Bu, THF, Rt, 2 h; Cl₂SiMe₂, −78° C., 16 H, 64% Yield; (ii) KOT-Bu, 18-cr-6, Et₂O, Rt, 16 H, 71% yield.

FIG. 12A and FIG. 12B are schemes showing: (FIG. 12A) ROMP of trans-SiCH (see Table 1-3 for conditions) and (FIG. 12B) Photograph of glassy white poly(trans-SiCH).

FIG. 13 is a cropped ¹H NMR spectra (400 MHz, CDCl₃) of trans-SiCH (top) and cis-SiCH (bottom).

FIG. 14 is a cropped ¹H NMR spectra (400 MHz, C₆D₆) of trans-SiCH showing no appearance of cis-SiCH olefinic peak δ 5.61 after storage in the dark at room temperature.

FIG. 15 is a ¹H NMR spectra (400 MHz, CDCl₃) showing stability of Ph(SiMe₂)₄Ph to cis-CO ROMP. Top: Ph(SiMe₂)₄Ph (top); middle: PCO and Ph(SiMe₂)₄Ph; bottom: PCO.

FIG. 16 is a cropped IR spectrum of P(trans-SiCH) indicating the cis and trans alkenes in the polymer backbone.

FIG. 17 is a UV-Vis response of trans-SiCH and cis-SiCH ([monomer]=0.02 mM in THF).

FIG. 18 is a UV-Vis response of poly(trans-SiCH), trans-SiCH and cis-SiCH ([sample]=0.02 mM in THF). [Poly(trans-SiCH)]=0.00952 mg mL⁻¹.

FIG. 19 is a full image of differential scanning calorimetry of poly(trans-SiCH). Heating rate: 20° C. min⁻¹, cooling rate: 10° C. min⁻¹.

FIG. 20 is a dihedral scan of trans-SiCH. Highlighted dihedral rotation scan was performed at increments of 10 degrees (0) to study the unimolecular pathway for trans-to-cis isomerization.

FIG. 21 is a dimerization Gibbs free energies (in kcal/mol) of trans-SiCH and trans-cycloheptene to form diradical intermediates that can lead to trans-to-cis isomerization through a bimolecular pathway. While the dimerization of trans-cycloheptene, which has a significantly higher ring strain, is thermoneutral, the dimerization of trans-SiCH is highly unfavorable.

FIG. 22A and FIG. 22B shows optimized geometries of the PB-cis fragment at 0 nN external force (FIG. 22A) and 1 nN external force (FIG. 22B). The structures show that at low to moderate forces, a low-energy dihedral rotation that leads to better alignment of the central cis bond with the force vector leads to a significant extension of the fragment resulting in non-linear extension in these regions. Atoms that had external force applied to them are highlighted in green.

FIG. 23A, FIG. 23B, FIG. 23C, and FIG. 23D shows optimized geometries of SiCH monomer at 0 nN external force (FIG. 23A), 3 nN external force (FIG. 23B) and geometries of PCO monomer at 0 nN external force (FIG. 23C), 3 nN external force (FIG. 23D). Both Si—Si and Si—C bonds extend more significantly when compared to C—C bonds. Similarly, C—Si—Si and Si—Si—Si angles distort to a significantly higher extent when compared to C—C—C angles. Atoms that had external force applied to them are highlighted in green.

FIG. 24a, FIG. 24b, and FIG. 24c show: (FIG. 24a) Ring-opening metathesis polymerization of trans-silacycloheptene. (FIG. 24b) Acyclic diene metathesis of dichlorodipentenylsilane with Si—Cl bonds that can be readily functionalized. (FIG. 24c) New oligosilane-dienes that undergo acyclic diene metathesis to form polymers with variable silicon contents (this work)

FIG. 25a, FIG. 25b, FIG. 25c show: (FIG. 25a) Cropped ¹H NMR spectrum of poly(epoxy-disilane) in CDCl₃ highlighting the presence of cis- and trans-epoxide protons. (FIG. 25b) 1H-¹H COSY depicting cross-peaks between the cis/trans-epoxide protons and neighboring CH₂ resonance. (FIG. 25c) ¹H-¹³C HSQC confirm the chemical shifts of carbon environments of cis- and trans-epoxides.

FIG. 26 shows the calculated elasticity of epoxidized monomers containing different numbers of dimethylsilylene or methylene groups (left). Optimized structures of monomers with three dimethylsilene (bottom) or methylene (top) groups at force-free conditions (top) and 3 nN external applied force (right). Carbon is shown in gray, silicon in yellow, and oxygen in red, while hydrogens are omitted for clarity.

FIG. 27 shows representative single-molecule force-extension curves of P5-P8 normalized at 500 pN.

FIG. 28 is a scheme showing the synthesis of oligosilane dienes via pentenyl Grignard reagent.

FIG. 29 is a scheme showing the ADMET polymerizations of Si-dienes 1-4.

FIG. 30 is a scheme showing the postpolymerization epoxidation of polymers P1-P4.

FIG. 31 is an ¹H NMR spectrum of Si₃-epoxide in CDCl₃.

FIG. 32 is a ¹³C NMR spectrum of Si₃-epoxide in CDCl₃.

FIG. 33 is a ²⁹Si NMR spectrum of Si₃-epoxide in CDCl₃.

FIG. 34 is an FTIR spectrum of Si₃-epoxide.

FIG. 35 shows size exclusion chromatograms of oligosilane dienes 1-4 (1 mg mL-1 solutions in THF, FT) relative to polystyrene standards.

FIG. 36 shows absorption spectra of Si₃-diene (3) and Si₄-diene (4) in THF at room temperature.

FIG. 37 shows absorption spectra of polySi₃-diene (P3) and polySi₄-diene (P4) in THF at room temperature.

FIG. 38 shows absorption spectra of poly(epoxy-trisilane) (P7) and poly(epoxy-tetrasilane) (P8) in THF at room temperature.

FIG. 39 shows the normalized computed force-extension curves of SiMe₂— (left) and CH₂—containing monomers (with n—0-4 repeating units of SiMe₂ or CH₂ as shown in inset). All distances were normalized by terminal Me group distance at force-free conditions. Force is applied to the terminal methyl groups. Linear fits shown as solid lines were generated using all points forces above 1.5 nN.

FIG. 40 shows intrinsic differences in ring strain of trans- and cis-1 enable polymerization, depolymerization, and reconstruction by multiple olefin metathesis mechanisms. ROMP=ring-opening metathesis polymerization; RCM=ring-closing metathesis; ROIMP=ring-opening-insertion metathesis polymerization; RO-CMP=ring-opening/cross-metathesis polymerization.

FIG. 41 shows size exclusion chromatography (SEC) elugram of P1 before (dashed) and after (solid) purification by recycling SEC, normalized to the largest molecular weight peak at 4.74 min ([P1]=1.00 mg mL-1, THF, RT) relative to polystyrene standards. P1 (before RSEC) Mₙ=2.03 kg mol⁻¹, M_{w}/Mₙ=5.03. P1 (after RSEC) Mₙ=13.0 kg mol⁻¹, M_{w}/Mₙ=1.23.

FIG. 42 shows cropped ¹H NMR spectra of pure cis-1 (top), after 16 hours of depolymerization (middle), and pure P11.23 (bottom) showing 55% depolymerization to cis-1.

FIG. 43 shows size exclusion chromatography (SEC) elugrams of recovered P1 over time ([P1]=0.75 mg mL⁻¹, THF, RT). See Table 3-1 for molecular weight characteristics of recovered P1.

FIG. 44a show FIG. 44b show (FIG. 44a) proposed mechanism for ring-opening/cross-metathesis step polymerization yielding highly alternating copolymers. (FIG. 44b) Synthesis of P2via RO-CM step polymerization.

FIG. 45 show cropped ¹H NMR spectra (CDCl₃, 400 MHz) comparing the olefinic regions of P1 (top), P2 (middle), and dimethyl fumarate (bottom). There is no evidence of signals consistent with consecutive homopolymerization repeat units, supporting a highly alternant copolymer microstructure.

FIG. 46 is a cropped and annotated crude ¹H NMR spectra (400 MHz, chloroform-d) of depolymerization of P1_{11.1} to cis-1 (28% conversion). Reaction conditions: 1 mol % G1, 0.16 M DCM, 16 h.

FIG. 47 is a cropped crude ¹H NMR spectrum (400 MHz, chloroform-d) from the unsuccessful CM of cis-1 and 1-hexene. The reaction proceeded to give 5-decene and cis-1. FIG. 48 is a cropped ¹H NMR spectra (400 MHz, chloroform-d) of the RO-CM product, 2. The olefinic region shown only indicates the trans isomer.

FIG. 49 is a cropped ATR-IR spectra of P2 indicating the α,β-unsaturated carbonyl at 1706 cm⁻¹ as well as a SiMe functional group at 1257 cm⁻¹.

FIG. 50a, FIG. 50b, FIG. 50c, FIG. 50d, and FIG. 50e show an attempted synthesis of alternating polymer P2 from homopolymer P1 with cropped ¹H NMR spectra (400 MHz, chloroform-d) of olefinic region taken at a reaction time of (FIG. 50a) 15 minutes and (FIG. 50b) 2 hours, as well as SEC elugrams of (FIG. 50c) P1 homopolymer, (FIG. 50d) 15 minute reaction, and (FIG. 50e) 2 hour reaction. Molecular weight determined by size exclusion chromatography relative to polystyrene standards at 254 nm (THF, [Sample]=1.00 mg mL⁻¹, 40° C., 0.35 mL min-1, 10 L injection).

FIG. 51a, FIG. 51b, FIG. 51c, and FIG. 51d show the synthesis of alternating polymer P2 with the associated cropped ¹H NMR spectrum (400 MHz, chloroform-d) of the olefinic region of reactions quenched after (FIG. 51a) 15 minutes and (FIG. 51b) 7 days, as well the associated SEC elugram of reactions quenched after (FIG. 51c) 15 minutes and (FIG. 51d) 7 days. Molecular weight determined by size exclusion chromatography relative to polystyrene standards at 254 nm (THF, [Sample]=1.00 mg mL⁻¹, 40° C., 0.35 mL min⁻¹, 10 L injection).

### DETAILED DESCRIPTION

The presently disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a compound selected from:

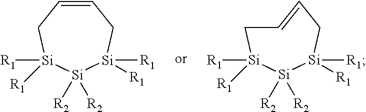

wherein: R₁ is aryl; and R₂ is C₁-C₄ alkyl. As used herein, C₁-C₄ alkyl includes methyl, ethyl, n-propyl, isopropyl, n-butyl, isobutyl, sec-butyl, and tert-butyl. In particular embodiments, the C₁-C₄ alkyl is methyl. As used herein, “aryl” refers to a group derived from arenes by removal of a hydrogen atom from a ring carbon atom. A representative aryl group is phenyl.

In particular embodiments, the compound is selected from:

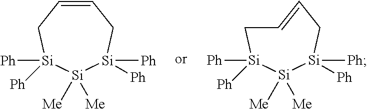

wherein: Ph is phenyl and Me is methyl.

In more particular embodiments, the compound is:

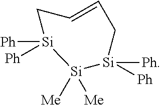 [SMILES: C[Si]1(C)[Si](c2ccccc2)(c2ccccc2)CC=CC[Si]1(c1ccccc1)c1ccccc1]

In other embodiments, the presently disclosed subject matter provides a method for synthesizing the compounds referenced immediately hereinabove, the method comprising:
(a) contacting 1,1,1,3,3,3-hexamethyl-2,2-diphenyltrisilane with potassium tert-butoxide in tetrahydrofuran for a first period of time at room temperature and then adding Cl₂SiCH₃ at −78° C. for a second period of time to form 1,1,1,3,3,5,5,5-octamethyl-2,2,4,4-tetraphenylpentasilane;
(b) contacting 1,1,1,3,3,5,5,5-octamethyl-2,2,4,4-tetraphenylpentasilane with potassium tert-butoxide and 18-crown-6 in diethyl ether at room temperature for a third period of time to form a oligosilyldianion having the following chemical structure:

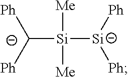 [SMILES: C[Si](C)(C(c1ccccc1)c1ccccc1)[Si-](c1ccccc1)c1ccccc1]

(c) reacting the oligosilyldianion of step (b) with:
(i) (Z)-1,4-dichlorobutene in toluene at room temperature for a fourth period of time to form:

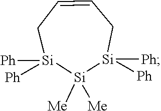 [SMILES: C[Si]1(C)[Si](c2ccccc2)(c2ccccc2)CC=CC[Si]1(c1ccccc1)c1ccccc1]

or
(ii) (E)-1,4-dichlorobutene in toluene at room temperature for a fifth period of time to form:

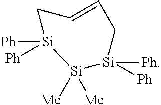 [SMILES: C[Si]1(C)[Si](c2ccccc2)(c2ccccc2)CC=CC[Si]1(c1ccccc1)c1ccccc1]

In other embodiments, the presently disclosed subject matter provides a polymer having the following structure:

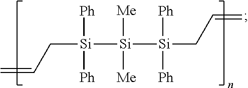

wherein n is an integer from 1 to 10,000.

In other embodiments, the presently disclosed subject matter provides a method for preparing a polymer having the following structure:

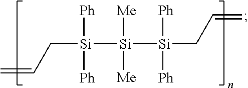

wherein n is an integer from 1 to 10,000; the method comprising:
contacting

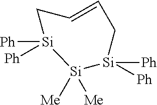 [SMILES: C[Si]1(C)[Si](c2ccccc2)(c2ccccc2)CC=CC[Si]1(c1ccccc1)c1ccccc1]

Grubbs 2nd generation catalyst in dichloromethane at room temperature for a sixth period of time.

A Grubbs 2nd generation catalyst (benzylidene-bis(tricyclohexylphosphino)-dichlororuthenium) can have the following chemical structure:

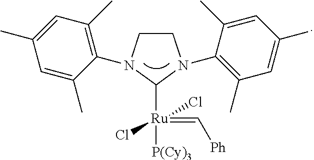

In other embodiments, the presently disclosed subject matter provides a polymer having the following structure:

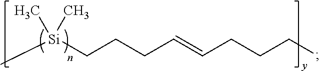

wherein: n is an integer selected from 1, 2, 3, and 4; and y is an integer from 1 to 10,000.

In other embodiments, the presently disclosed subject matter provides a method for preparing a polymer having the following structure:

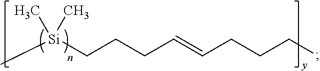

wherein: n is an integer selected from 1, 2, 3, and 4; and y is an integer from 1 to 10,000; the method comprising:
contacting

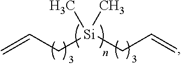

wherein n is an integer selected from 1, 2, 3, and 4, with Schrock's molybdenum catalyst (Mo═CHCMe₂Ph(═N—C₆H₃-i-Pr₂-2,6)(OCMe(CF₃)₂)₂) for a period of time to form a polymer having the following structure:

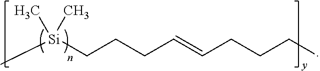

In other embodiments, the presently disclosed subject matter provides a polymer having the following structure:

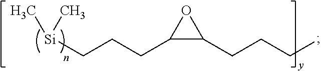

wherein: n is an integer selected from 1, 2, 3, and 4; and y is an integer from 1 to 10,000.

In other embodiments, the presently disclosed subject matter provides a method for preparing a polymer having the following structure:

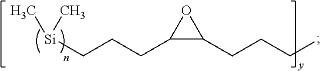

wherein: n is an integer selected from 1, 2, 3, and 4; and y is an integer from 1 to 10,000; the method comprising:
contacting

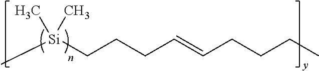

with meta-chloroperoxybenzoic acid in dichloromethane for a period of time to form a polymer having the following structure:

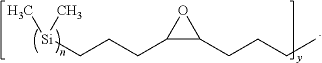

The term “about,” when used in connection with one or more numbers or numerical ranges, should be understood to refer to all such numbers, including all numbers in a range and modifies that range by extending the boundaries slightly above and slightly below the numerical values set forth by, for example, in some embodiments, +/−20%, +1-15%, +/−10%, +1-5%, +/−4%, +/−3%, +/−2%, and +/−1%. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references, i.e., “one or more,” unless the context clearly dictates otherwise. The present disclosure also contemplates other embodiments “comprising,” “consisting of” and “consisting essentially of,” the embodiments or elements presented herein, whether explicitly set forth or not. Likewise, the term “include” and its grammatical variants are intended to be non-limiting, such that recitation of items in a list is not to the exclusion of other like items that can be substituted or added to the listed items.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration and are not to be construed as limiting in any manner to make compounds of the disclosure by other methods.

### Example 1

### Synthesis and Ring-Opening Metathesis Polymerization of a Strained Trans-Silacycloheptene and Single-Molecule Mechanics of its Polymer

### Overview

The cis- and trans-isomers of a silacycloheptene were selectively synthesized by the alkylation of a silyl dianion, a novel approach to strained cycloalkenes. The trans-silacycloheptene (trans-SiCH) was significantly more strained than the cis isomer, as predicted by quantum chemical calculations and confirmed by crystallographic signatures of a twisted alkene. Each isomer exhibited distinct reactivity toward ring-opening metathesis polymerization (ROMP), where only trans-SiCH afforded high-molar-mass polymer under enthalpy-driven ROMP. Without wishing to be bound to any one particular theory, it was thought that the introduction of silicon might result in increased molecular compliance at large extensions. Accordingly, we compared poly(trans-SiCH) to organic polymers by single-molecule force spectroscopy (SMFS). Force-extension curves from SMFS showed that poly(trans-SiCH) is more easily overstretched than two carbon-based analogues, polycyclooctene and polybutadiene, with stretching constants that agree well with the results of computational simulations.

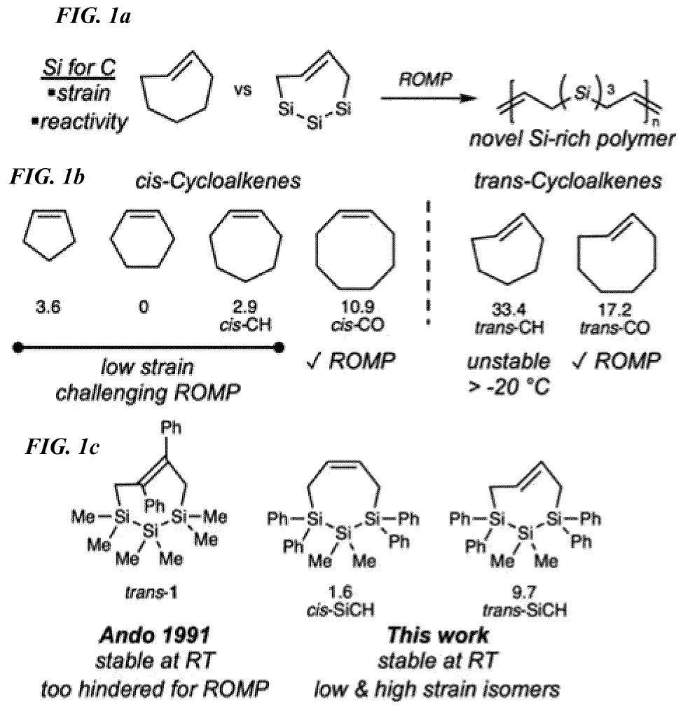

More particularly, the presently disclosed subject matter provides the geometrically selective synthesis of trans- and cis-silacycloheptenes via a novel synthetic strategy and probe the effect of Si for C substitution on ring-opening metathesis polymerization (ROMP, FIG. 1a). The efficiency of ROMP, and the reverse depolymerization, is exquisitely sensitive to monomer structure. High-ring-strain monomers (e.g., >10 kcal mol⁻¹), as exemplified by norbornene, dicyclopentadiene, and cyclobutene, rapidly polymerize in an enthalpically driven process. In the simple small rings cis-cyclopentene to cis-cyclooctene, however, only cis-cyclooctene (cis-CO) has high strain (FIG. 1b).

### BACKGROUND

Cis- and trans-CO exhibit several interesting difference in ROMP reactivity. Grubbs reported that trans-CO undergoes living ROMP, Walker et al, 2009, in contrast to the lower strain cis-CO where secondary metathesis (e.g., chain transfer) reactions eroded molecular weight control. Interconversion of cis and trans-cycloalkenes also can facilitate chemical recycling. Recently, Wang et al. demonstrated closed-loop chemical recycling of bicyclic monomers containing cyclooctene rings: Sathe et al., 2021, trans isomers (prepared by photoisomerization of the cis isomer) underwent rapid ROMP, while the linear polymer could be depolymerized to the low-strain cis monomer. Chen et al., 2021.

Due to the longer C—Si bond, substitution of at least one carbon atom in trans-CH with a silicon atom partially alleviates ring strain and results in room-temperature-stable trans-cycloalkenes, as first reported by Shimizu et al., 1991, and further developed by Sanzone and Woerpel, 2016, and Fang et al., 2018, and others. Krebs et al., 1997. Thus, the Si's size and distinctive properties have implications for both the ability to generate Si-containing cycles and their subsequent polymerization.

At the same time, we recognized that oligosilanes of the general formula SinR2n+2 possess more low-energy conformations with lower barriers to interconversion than alkanes' Michl and West, 2000; Albinsson et al., 1996, and that introduction of a conformationally flexible oligosilane into a macromolecule could result in striking difference in the force-coupled extensional behavior of the macromolecules relative to all-carbon congeners. Single-molecule force spectroscopy (SMFS) implemented via an atomic force microscope is a quantitative probe of the elasticity of single polymer chains, as well as intrastrand conformational change. Marszalek et al., 1998; Binnig et aL, 1986; Evans and Ritchie, 1999; Wang et al, 2013; Luo et al., 2016; Li et al, 2000; Zhang et al, 2008; Song et al., 2019.

Without wishing to be bound to any one particular theory, it was thought that SMFS could facilitate comparison of all carbon backbones to a Si-enriched polymer strand. For these reasons, we became interested in the ROMP reactivity of cycloalkenes containing oligosilyl fragments, as well as the potential for ROMP to achieve novel Si-rich polymers of sufficiently high molar mass (>50 kg mol⁻¹) for macromolecular characterization by SMFS (FIG. 1a). Other approaches to polysilanes, e.g., dehydrocoupling polymerization or Wurtz polymerization, suffer from low molar mass or poor control of dispersity. Tilley, 1993; Jones et al., 1996; Klausen and Ballestero-Martinez, 2022.

While silicon-containing rings and dienes have been investigated for ROMP and acyclic diene metathesis (ADMET), McQuade et al., 2022, the silicon functional groups investigated have focused on siloxane, Brzezinska et al., 2000; Cushman et al., 2021, silyl ether, Johnson et al., 2022; Shieh et al., 2020; Husted et al., 2021, and acylsilane, Ratushnyy and Zhukhovitskiy, 2021, containing alkenes. Oligosilanes, compromising consecutive Si—Si bonds, have not previously been investigated in ROMP or ADMET. The Si—Si bond is sensitive to cleavage by late transition metals (e.g., Rh, Pd, Pt), Rosenberg, 2003; Jiang et al., 2022, which may contribute to the lack of prior investigation of oligosilyl monomers.

### Scope

The presently disclosed subject matter provides the synthesis of a room-temperature stable and ROMP-reactive trans-silacycloheptene (trans-SiCH, FIG. 1c). The isomeric cis-silacycloheptene (cis-SiCH) is low strain and does not readily undergo enthalpy-driven ROMP. Control experiments and spectroscopic characterization are consistent with the stability of the oligosilyl chain to Ru-metathesis catalysts. The poly(trans-SiCH) is a novel example of a silicon-rich polymer, distinct from polysilanes (Si—Si), polysiloxanes (Si—O—Si), polysilazanes (Si—N—Si), and polycarbosilanes (Si—C—Si), Mark, 1989; Birot et al., 1995; Miller and Michl, 1989; Barroso et al., 2019, and of sufficiently high molar mass for SMFS characterization of single-molecule mechanics.

### Results and Discussion

### Silacycloheptene Synthesis

While Ando's silacycloheptene trans-1 is stable to thermal isomerization at room temperature, the synthesis reveals representative challenges in the preparation of trans-cycloalkenes for ROMP (FIG. 11a). The synthesis of trans-1 was low-yielding: reductive coupling of 2,3-diphenylbutadiene and 1,3-dichlorohexamethyltrisilane provided cis-1 (23% yield), which was photoisomerized (254 nm) in benzene-d₆ to trans-1 (19% yield), with a photostationary state close to 1:1 E:Z. Shimizu et al., 1991. The tetrasubstituted stilbene is too sterically hindered for ROMP, but conjugation with aromatic rings, Waldeck, 1991, is likely necessary for selective alkene excitation relative to the trisilane chromophore. Gilman, 1964.

Recognizing the need for geometrically pure cycloalkenes, we hypothesized that isomeric silacycloheptenes could be obtained by the reaction of isomeric 1,4-dichlorobutenes with the same oligosilyl dianion (FIG. 11b). We and others have previously described the synthesis of α,ω-dipotassiooligosilyl dianions (x=2-3), Marro et al., 2017, via end-selective desilylation, Kayser et al., 2002, and have shown that these dianions are suitable for gram-scale synthesis of cyclohexasilanes, Press et al., 2017; Marro et al., 2018; Marro and Klausen, 2019; Marro et al., 2019; Fischer et al., 2003, and cyclosilaboranes. Purkait et al., 2019; Markov et al., 2004.

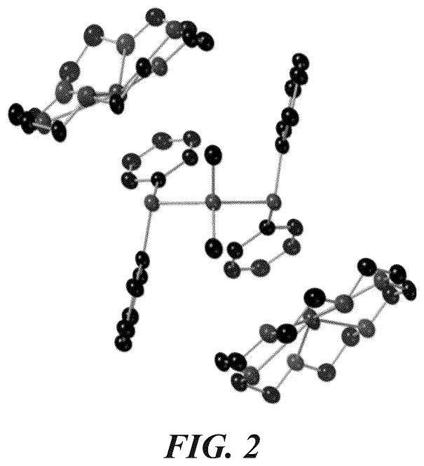

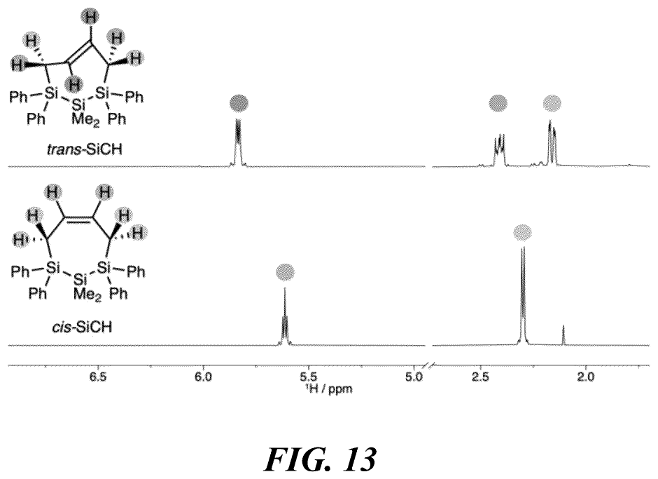

To make the seven-membered ring, we synthesized novel dianion 4 by displacement of terminal trimethylsilane groups with potassium tert-butoxide (FIG. 11c). An X-ray crystal structure of 4 (FIG. 2) was consistent with crystal structures of higher disilanides, Marro et al., 2017, in which K+ engaged in a cation-π interaction with a phenyl group rather than a contact ion pair with the silyl anion. In dilute toluene, coupling of 4 with either trans- or cis-1,4-dichlorobutene proceeded smoothly to provide geometrically pure trans- and cis-SiCH (FIG. 13). In other solvents, competitive oligomerization and/or dianion decomposition was observed. The SiCH isomers could be isolated by silica gel chromatography, although generally in lower yield (ca. 30%), which was hypothesized to result from the acid sensitivity of the allylic silane. Pure samples could instead be obtained by precipitation or crystallization (50-78% yield).

### Single-Crystal X-Ray Crystallography

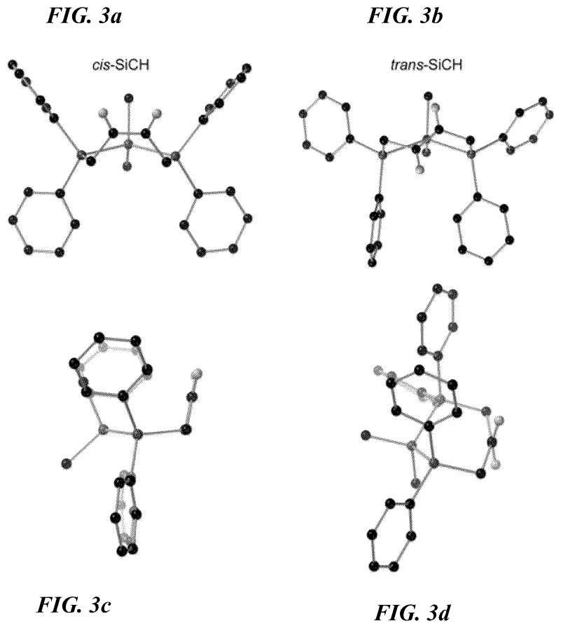

The molecular structures of the isomeric silacycloheptenes were determined by single-crystal X-ray crystallography, which confirmed the isomer assignments. The conformation of cis-SiCH is boat-like, with three coplanar Si atoms and a central mirror plane of symmetry (FIG. 3a), while trans-SiCH has a C₂-axis of symmetry (FIG. 3b). The symmetry of trans-SiCH is similar to Ando's trans-1, and ¹H and ¹³C NMR chemical shifts also are similar for the two strained cycloalkenes (Table 1-1).

TABLE 1-1
Chemical shifts (in ppm) of Ando's trans-1 and trans-SiCH.

| | 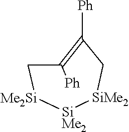 | 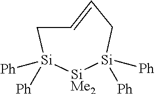 |
|---|---|---|
| Peak | | |
| (benzene-d₆) | trans-1 | trans-SiCH |
| ¹H (olefin) | n/a | 5.84 |
| ¹H (allylic) | 3.22 and 1.76 | 2.40 and 2.16 |
| ¹³C (olefin) | Not reported | Not reported |
| ¹³C (allylic) | Not reported | Not reported |
| Peak | | |
| (chloroform-d) | trans-1 | trans-SiCH |
| ¹H (olefin) | n/a | 5.80 |
| ¹H (allylic) | 2.90 and 1.50 | 2.40 and 2.16 |
| ¹³C (olefin) | 126.70 | 127.77 |
| ¹³C (allylic) | 26.60 | 19.07 |

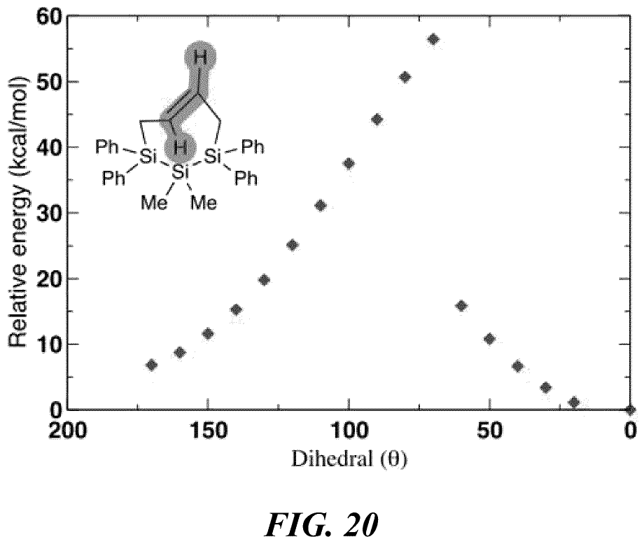

Ring strain calculations (M06/def2-TZVPP-CPCM-(DCM)//B3LYP-D4/def2-SVP) predicted that cis-SiCH has lower strain (1.6 kcal mol⁻¹) while trans-SiCH has higher strain (9.7 kcal mol⁻¹) (FIG. 20). These calculations are consistent with the crystal structures. In low-strain cis-SiCH, the alkene is planar, as indicated by a planar C═C bond (FIG. 3c). In contrast, the trans-SiCH olefin is twisted from planarity (FIG. 3d).

Table 1-2 summarizes some key structural parameters of the olefin in cis- and trans-SiCH, such as the torsion angle θ (<C27-C28-C29-C30), which is approximately 0 for cis-SiCH (planar olefin) and significantly less than 180° for trans-SiCH (twisted olefin). The bond lengths and angles are otherwise consistent with a double bond in both isomers. The C28-C29 bond distance in both isomers is basically the same (1.32 vs 1.33 Å) and consistent with a typical C═C bond (1.34 Å). The bond angles are close to 120°.

TABLE 1-2

[symbol]

[symbol]

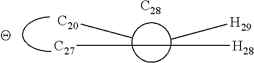

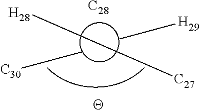

Selected Olefinic Structural Parameters

| structural parameter | abbreviation | cis-SiCH | trans-SiCH |
|---|---|---|---|
| ∠C27-C28-C29-C30 | Θ | −0.3(9)° | 149.9(2)° |
| ∠H28-C28-C29-C30 | n/a | 179.6° | −30.0° |
| distance C28 = C29 | n/a | 1.329(6) Å | 1.320(4) Å |
| ∠C27-C28-C29 | n/a | 126.1(5)° | 122.4(3)° |

### Thermal Stability

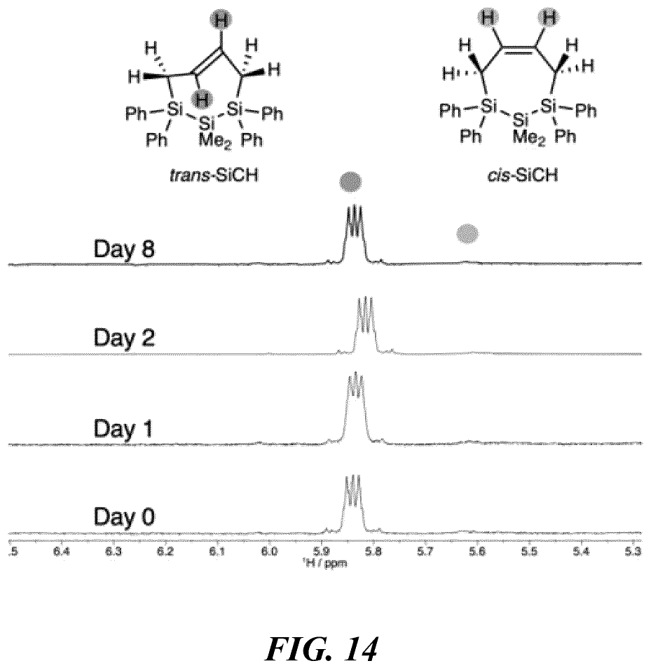

Due to the rapid room-temperature Z→E isomerization of trans-CH, we investigated the stability of trans-SiCH to storage at room temperature. Over the course of 8 days, a benzene-d₆ solution of trans-SiCH stored in the dark showed no appearance of signals corresponding to cis-SiCH by ¹H NMR spectroscopy (FIG. 14). This result is consistent with Ando's report that trans-1 does not isomerize at room temperature. Shimizu et al., 1991.

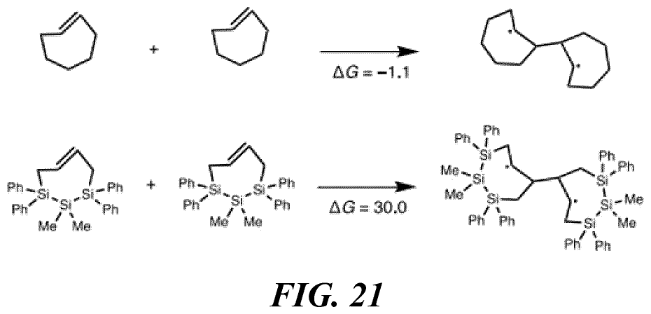

The rapid thermal isomerization of trans-CH to cis-CH has been attributed to a bimolecular mechanism involving a 1,4-biradical intermediate, as calculations of unimolecular isomerization via a 1,2-biradical suggested that trans-CH should be stable at room temperature. Squillacote et al., 2005. Similarly, DFT simulations estimated a barrier around 50 kcal mol⁻¹ to thermal isomerization of trans-SiCH via a 1,2-biradical, based on a dihedral scan of the carbon/carbon double bond (FIG. 20 and FIG. 21). Furthermore, we also investigated a thermal isomerization of trans-SiCH through a bimolecular mechanism. While the dimerization toward the formation of 1,4-biradical of trans-CH was slightly exergonic (ΔG=−1.1 kcal/mol), the dimerization of trans-SiCH, which is significantly less strained than trans-CH, was highly endergonic (ΔG=30.0 kcal/mol) making isomerization through a bimolecular mechanism kinetically inaccessible.

### Ring-Opening Metathesis Polymerization

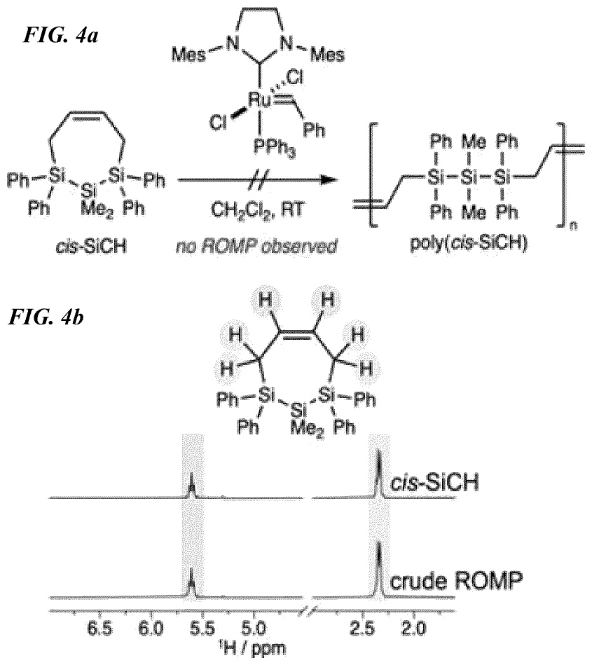

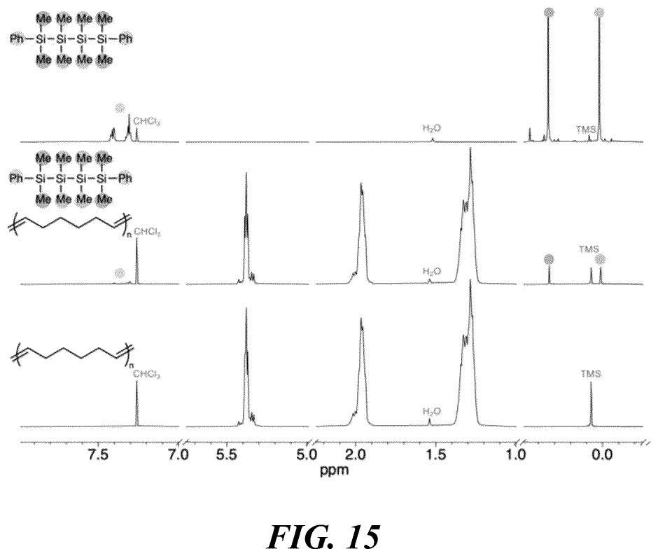

Using the second-generation Grubbs catalyst (G2, FIG. 4a), we attempted ROMP of cis-SiCH. The comparatively poor solubility of cis-SiCH at room temperature required high dilution ([cis-SiCH]₀=0.10 M in CH₂Cl₂) not usually effective for entropy-driven ROMP of low strain monomers, Hejl et al., 2005, and ROMP was not observed (Table 1-3). Starting material was recovered (FIG. 4b), which indicated that the Si—Si bonds of SiCH were stable to G2, a conclusion supported by also evaluating cis-CO ROMP in the presence of a tetrasilane additive (FIG. 15).

TABLE 1-3
ROMP of cis- and trans-SiCH^{a}

| | | initi- | | | | yield | Mn (kg | |
|---|---|---|---|---|---|---|---|---|
| entry | monomer | ator | [M]₀/[I] | Time | | (%) | mol⁻¹)^{b} | M_{w}/Mₙ^{b} |
| 1 | cis-SiCH | G2 | 1000/1 | 5 | h | 0 | n.d. | n.d. |
| 2 | cis-SiCH | G2 | 1200/1 | 5 | h | 0 | n.d. | n.d. |
| 3 | cis-SiCH | G2 | 1200/1 | 24 | h | 0 | n.d. | n.d. |
| 4 | trans-SiCH | G2 | 500/1 | 1 | h | 36 | 62.6 | 3.50 |
| 5 | trans-SiCH | G2 | 1000/1 | 1 | h | 70 | 51.5 | 2.43 |
| 6 | trans-SiCH | G2 | 100/1 | 1 | h | 33 | 39.0 | 3.02 |
| 7 | trans-SiCH | G1 | 500/1 | 1 | h | 64 | 62.3 | 3.56 |
| 8 | trans-SiCH^{c} | G1 | 500/1 | 1 | h | 4.0 | 7.37 | 1.38 |

^{a}ROMP of cis-SICH and trans-SiCH were performed at room temperature with solutions of 0.1 and 2.4M in DCM, respectively.
^{b}Determined by size exclusion chromatography relative to polystyrene standards at 254 nm (THF, [poly(trans-SiCH)] = 1 mg mL⁻¹, 40° C., 0.35 mL min⁻¹, 10 μL injection).
^{c}With 60 equiv PPh₃ relative to G1.

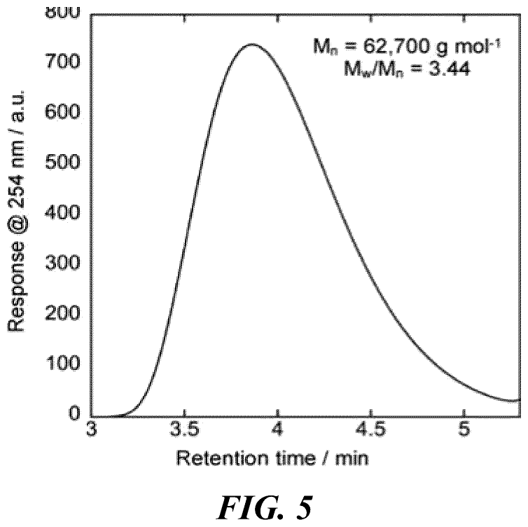

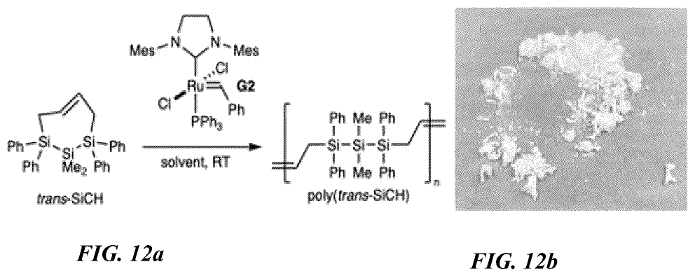

In contrast, under similar conditions (FIG. 12a), within 15 min trans-SiCH underwent ROMP to provide a glassy white polymer (FIG. 12b). Size exclusion chromatography (SEC, FIG. 5 and Table 1-3, entry 4) showed a high molar mass (Mₙ=62,700 g mol⁻¹), relatively disperse polymer (M_{w}/Mₙ=3.44). Variation of the ratio of monomer to initiator had little effect on Mₙ but reduced M_{w}/Mₙ from ca. 3.5 to 2.2 (entries 5 and 6). These data suggest that trans-SiCH ROMP is not living under the conditions investigated. While comparable results were obtained with G2 and G1 (compare entries 4 and 7), the addition of excess PPh₃ (60 equiv), known to result in better control in ROMP of trans-CO10 and other cycloalkenes, Bielawski et al., 2001, dramatically reduced Mₙ to 7370 g mol⁻¹ while also providing narrower dispersity (3.50 vs 1.38, entry 8).

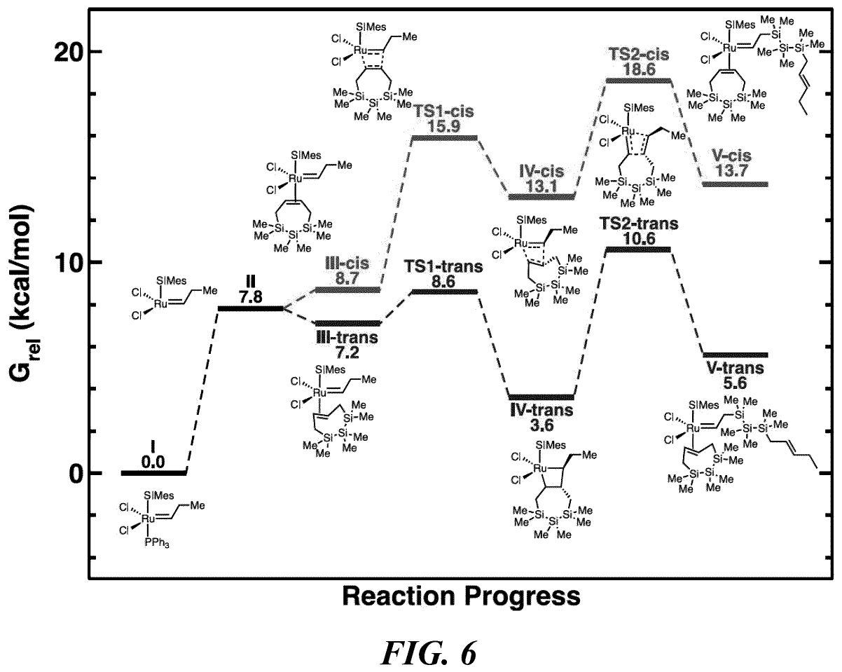

To better understand reactivity differences between trans- and cis-SiCH, we carried out DFT calculations of ring-opening metathesis with a simplified permethyloligosilane model substrate. The rate-determining step for both monomers was identified as the retro [2+2]-cycloaddition leading to ring opening (e.g., IV-V). This step was kinetically accessible (i.e., activation energies of 10.6 and 18.6 kcal mol⁻¹, respectively) for both monomers, relative to the phosphine ligand-bound intermediate (FIG. 6). While ring-opening metathesis is exergonic by 1.5 kcal mol⁻¹ for trans-SiCH (V-trans relative to III-trans and free trans-SiCH), however, it is endergonic for cis-SiCH by 6.0 kcal mol⁻¹ (V-cis relative to III-cis and free cis-SiCH), which is consistent with their respective ring strain and reactivity. The kinetically accessible barriers to cis-SiCH ROMP suggest that polymerization of cis-SiCH should be possible if an appropriate solvent and concentration were identified for entropy-driven ROMP.

### Poly(trans-SiCH) Characterization

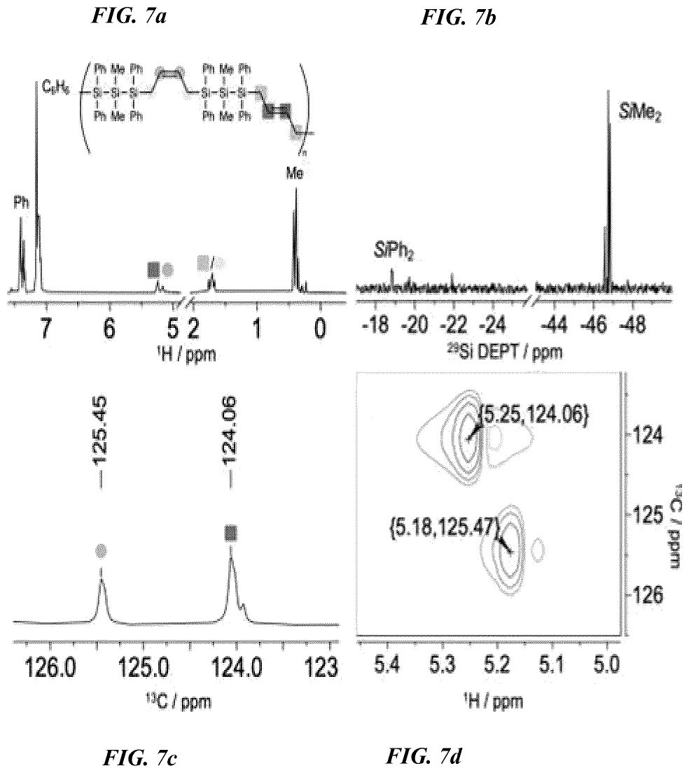

Poly(trans-SiCH) was fully characterized by ¹H, ¹³C, and ²⁹Si NMR spectroscopy (FIG. 7). Resonances consistent with the expected aromatic, vinylic, allylic, and methylsilane peaks were observed (FIG. 7a). The ²⁹Si distortionless enhancement by polarization transfer (DEPT), Blinka et al., 1984, spectrum showed resonances consistent with both methylsilanes and phenylsilanes (FIG. 7b). The assignment of the (5-45 resonances to the SiMe₂ moiety was based on the greater signal intensity expected for methylsilanes compared to phenylsilanes in a ¹H→²⁹Si polarization transfer NMR experiment; the methylsilane has six protons two bonds away (2J1H-²⁹Si=7-10 Hz), while the phenylsilane has four protons three bonds away. The relative chemical shifts are also consistent with internal and end group resonances in oligosilanes. Gupta and Lechner, 2008.

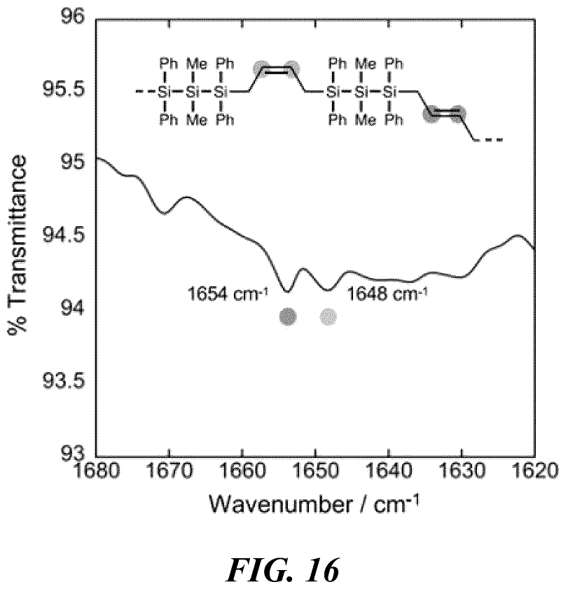

The ¹H NMR spectrum indicated that ROMP was not stereoselective, as expected for G2, as resonances consistent with the presence of both trans- and cis-alkenes (ca. 1.5:1) were observed at (5 5.25 and 5.16 (FIG. 7a). The major isomer was assigned to the trans-alkene based on the relatively downfield chemical shift of trans-SiCH compared to cis-SiCH. This result is consistent with ROMP of cis-CH using the same catalyst, which afforded a polymer containing predominantly the trans-olefin (ca. 5:1).2 The ¹³C NMR spectrum also showed two peaks consistent with two distinct vinylic environments (FIG. 7c). The ¹H-¹³C HSQC (heteronuclear single quantum coherence) spectrum (FIG. 7d) showed that the vinylic protons coupled to distinct vinylic carbons. The IR spectrum also showed resonances consistent with both cis and trans C═C stretching frequencies, Binder, 1963, in the 1660-1630 cm⁻¹ region (FIG. 16).

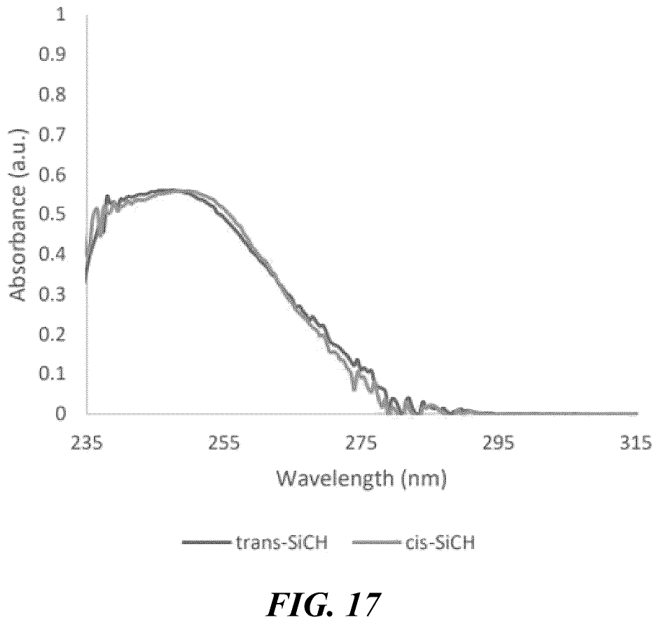

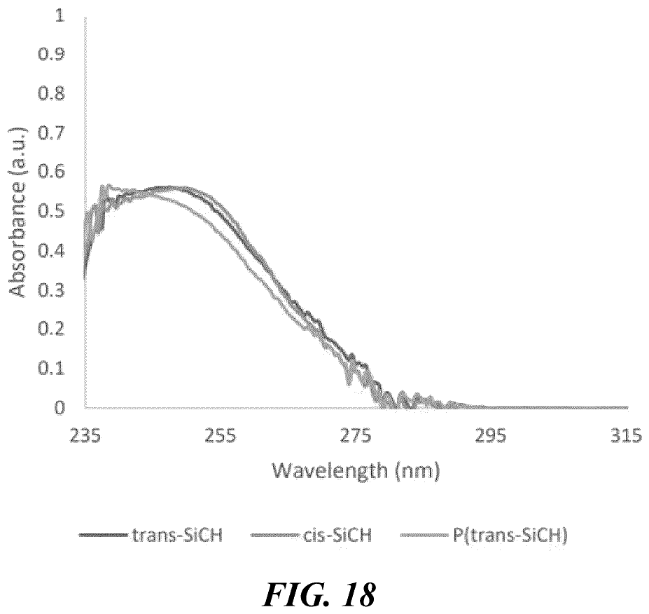

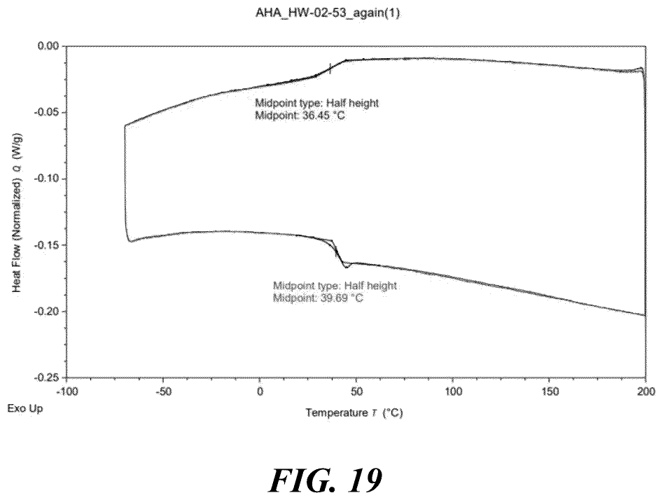

Solution-state UV-vis spectra were collected for both cis- and trans-SiCH, which were identical in λₘₐₓ of ca. 250 nm (FIG. 17). This result is consistent with prior reports of aryl-substituted trisilanes. Gilman et al., 1964. A similar absorption band was found for poly(trans-SiCH), suggesting retention of the trisilane chromophore after ring-opening metathesis polymerization (FIG. 18).

The thermal properties of poly(trans-SiCH) were determined by differential scanning calorimetry (DSC) and thermogravimetric analysis (TGA). The pyrolysis, under inert atmosphere, of polysilanes and polycarbosilanes to silicon carbide is well known, Yajima et al., 1978; Birot et al., 1995, with polysilanes typically beginning thermal decomposition around 200-250° C. Jiang et al., 2021.

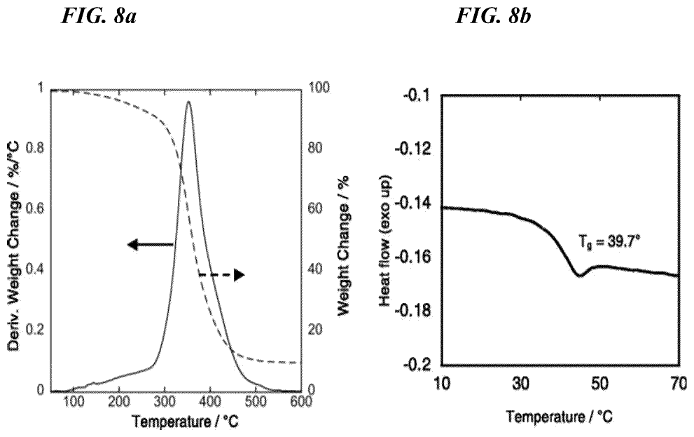

To identify the upper limit of the thermal stability of poly(trans-SiCH), we obtained TGA data under an inert nitrogen atmosphere. The maximum mass loss was observed at 355° C., with the onset of decomposition ca. 300° C. (FIG. 8a). This is a lower level of thermal stability than poly(cis-CO), which begins to degrade >400° C., Alonso-Villanueva et al., 2010, consistent with the retention of the trisilane in poly(trans-SiCH).

We also investigated the thermal properties below the decomposition temperature, as the elasticity of polyoctenamers depends on polymer stereoregularity: predominantly cis-alkenes results in a viscoelastic material, while predominantly trans-alkenes are semicrystalline. Rylski et al., 2022. Both exhibit a glass-transition temperature (T_{g}) ca. −80° C. Our poly(trans-SiCH), synthesized as an ca. 1.5:1 mixture of olefinic isomers, exhibited a T_{g} of 39.7° C. (FIG. 8b), significantly higher than polyCO, which was attributed to the stiffening effect of the four phenyl side chains.

### Single-Molecule Force Spectroscopy

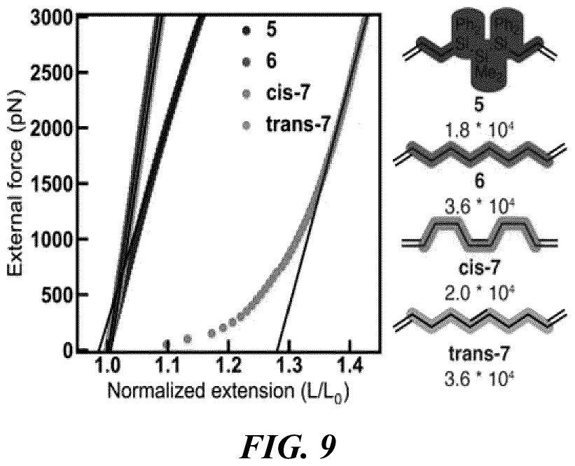

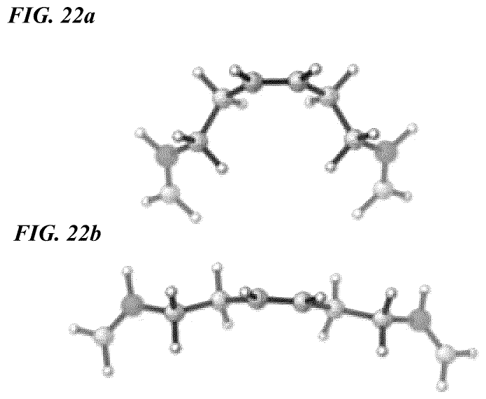

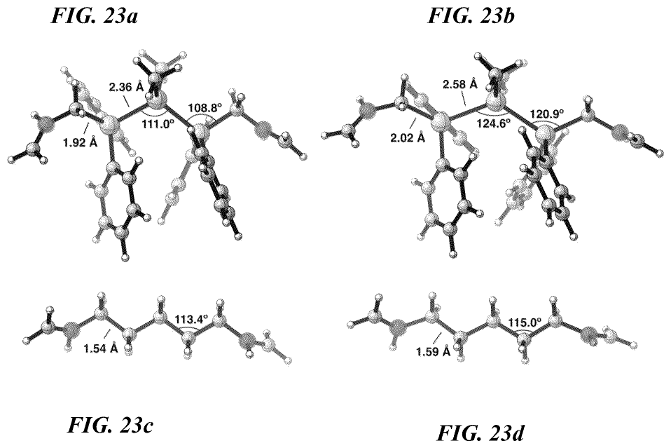

To compare the force-coupled behavior of silicon-rich polymers with all-carbon analogues, we carried out both computational modeling and experimental studies. We optimized under external force geometries of molecular fragments 5-7 (FIG. 9) that were designed to mimic the constitutional repeat units of poly-(SiCH) and poly(CO), as well as cis and trans polybutadiene. Here, we increased the external force in increments of 50 pN over the range of 0-3 nN on the internal sp2 carbons (FIG. 9). The distances between these two sp2 carbons were obtained at each external force and were normalized to their length of force-free optimized structures (i.e., L/L₀). The 5, 6, and trans-7 fragments show linear extension with increasing force, whereas the cis-7 fragment has a significantly larger extension in the low-force region, which can be attributed to the poor initial alignment of the central cis bond with the force vector at low forces due to low-energy dihedral rotations (FIG. 22). Therefore, we chose to obtain our linear fit over all four structures in the 1.5-3.0 nN force regions to estimate the elasticity of these fragments as the slope of external force vs. normalized extension. These calculations suggested that Si-rich materials are distorted more readily compared to their all-carbon analogues (FIG. 23) and would exhibit substantially lower elasticity. The SiCH monomer 5 has an elasticity (1.8×10⁴ pN per unit L₀) that is half the value for the all-carbon 6 (3.6×10⁴ pN per unit L₀). For 7, the elasticity is still higher than silane 5, for both the trans fragment (3.6×10⁴ pN per unit L₀) and cis fragment (2.0×10⁴ pN per unit L₀). Accounting for the 63% cis and 37% trans composition of PB, we estimate the elasticity for this composition (2.5×10⁴ pN per unit L₀) to still be 40% higher than that for SiCH.

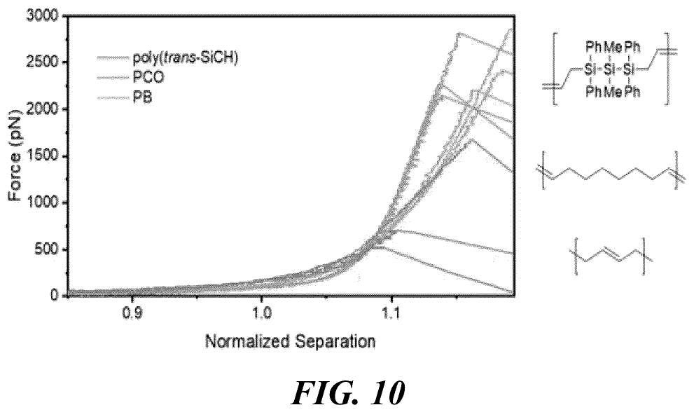

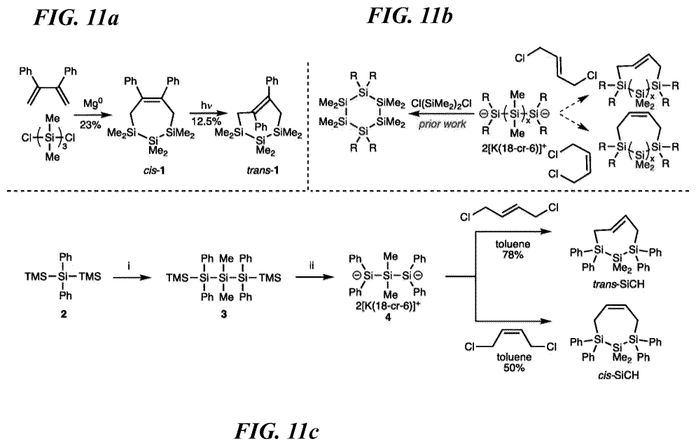

We performed single-molecule force spectroscopy (SMFS) on poly(trans-SiCH) and the carbon-based analogues poly-cyclooctene (PCO) and polybutadiene (PB). Prior work has shown that side chains have little impact on chain flexibility, and therefore the aromatic side chains of poly(trans-SiCH) could be neglected in selecting control polymers. Wang et al., 2013. The obtained force-extension curves are shown in FIG. 10. The curves were fit with a modified freely jointed chain model to obtain a nominal contour length L₀, and the extensional behavior beyond L₀ differs across the series. In particular, the slope of poly(trans-SiCH) is lower than that of both PCO and PB, consistent with the calculations (FIG. 9). To quantify the impact of the Si on elasticity, we compare the slope of each force-extension curve from 1000 pN to the point at which the polymer detaches (Table 1-4). Even at just three Si atoms per repeat, the elasticity of poly(trans-SiCH) is 1.4×10⁴ pN per unit L₀, significantly lower than 3.5×10⁴ and 2.4×10⁴ pN, respectively, for PCO and PB. Looking ahead, access to Si-rich polymers with enhanced compliance offers opportunities to probe the contributions of strand elasticity to the mechanical properties of polymer networks, including fracture. Wang et al., 2019.

TABLE 1-4
Slopes of the High-Force Region (F >
1000 Pn) of the Force-Extension Curves

| | elasticity (pN × 10⁴ per unit L₀) |
|---|---|
| poly(trans-SiCH) | 1.4 |
| PCO | 3.5 ± 0.1 |
| PB | 2.4 ± 0.2 |

### SUMMARY

The presently disclosed subject matter provides the synthesis of a new class of silicon-rich polymers derived from ring-opening metathesis polymerization (ROMP) of a strained trans-silacycloheptene. Geometrically pure isomers of the silacycloheptene were synthesized by a novel approach, alkylation of an α,ω-dipotassiodisilanide. Structure assignments for each isomeric monomer were confirmed by X-ray crystallography, which also provided structural signatures of low- and high-ring strain, e.g., a twisted olefin. The higher-strain trans-SiCH underwent rapid ROMP to provide a glassy organometallic polymer, which was fully characterized by ¹H, ¹³C, and ²⁹Si NMR spectroscopy, as well as IR and UV-vis spectroscopy and thermal characterization (e.g., TGA and DSC). Insights into the room-temperature stability to isomerization of trans-SiCH were obtained by quantum chemical calculations, which suggested a high thermal barrier to either unimolecular formation of a 1,2-biradical or bimolecular formation of a 1,4-biradical.

Without wishing to be bound to any one particular theory, it was thought that Si incorporation into the backbone could lead to distinctive force-coupled extensional behavior in single polymer chains. Computational models predicted that incorporating a trisilane in place of three methylenes in polycycloheptene would result in a more stretchable backbone than all comparable C—C backbones. Force-extension curves from SMFS showed that the extended poly(trans-SiCH) has a smaller spring constant compared to two carbon-based analogues, polycyclooctene and polybutadiene. The presently disclosed results point to the possibility of employing Si-rich polymers to prove the contribution of strand elasticity to the mechanical properties of bulk polymer networks.

### Example 2

### Systematic Investigation of Silicon Substitution on Single Macromolecule Mechanics

### Overview

Four unsaturated poly(carbooligosilane)s (P1-P4) were prepared via acyclic diene metathesis polycondensation of new oligosilane diene monomers (1-4). These novel polymers with varying main-chain Si incorporation have high trans internal olefin stereochemistry (ca. 80%) and molecular weights (9500-21,700 g mol⁻¹). Post-polymerization epoxidation converted all alkene moieties to epoxides and rendered the polymers (P5-P8) more electrophilic, which allowed for single-molecule force spectroscopy studies via a modified atomic force microscope setup with a silicon tip and cantilever. The single-chain elasticity of the polycarbooligosilanes decreased with increasing numbers of Si—Si bonds, a finding reproduced by quantum chemical calculations.

### BACKGROUND

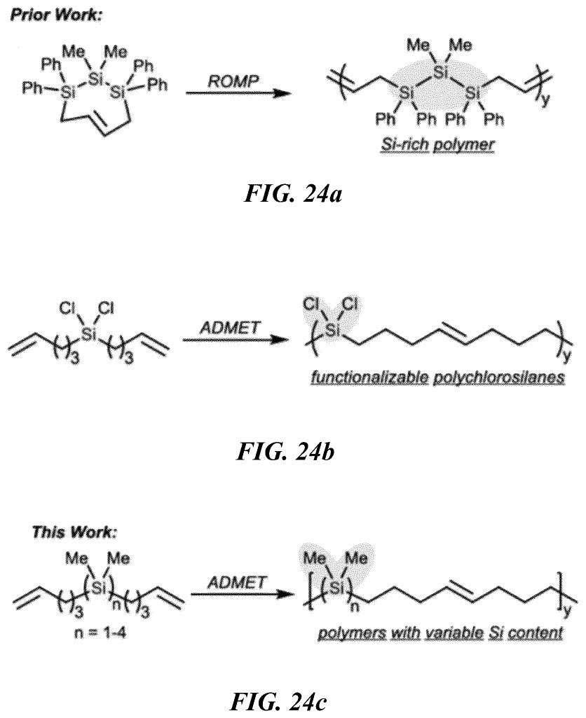

An alternative approach is the polymerization of metallic segments, e.g., oligosilyl chains capped with organic functional groups, which takes advantage of the functional group diversity of organic compounds while giving rise to macromolecules with alternating organic and metallic segments. Recent examples from Klausen et al. include Kumada polycondensation of dithienylcyclosilanes, Jiang et al., 2022, building on foundational examples from Ohshita, Kunai et al., 1996; Ohshita et al., 2000, and ring-opening metathesis polymerization (ROMP) of a strained cycloalkene with embedded oligosilanes (FIG. 24a). Wakefield et al., 2023.

These synthetic advances have resulted in the discovery of new properties, such as our finding of a reduced segment elasticity for enthalpic stretching in a poly(carbooligosilane) relative to all carbon backbones. In our earlier work using single-molecule force spectroscopy (SMFS), we found for polycyclooctene (PCO) an average segment elasticity of 3.5±0.1 pN×10⁴ per unit L₀. For the macromolecule poly(trans-SiCH), in which three of the carbon atoms of polycycloheptene were replaced with silicon atoms, the segment elasticity decreased to 1.4 pN×10⁴ per unit L₀.

The reduced elasticity of poly(trans-SiCH) is attributed to the lower stiffness of the C—Si and Si—Si bonds relative to the C—C bonds. The correlation between segment elasticity and bond stiffness can be intuitively understood by invoking the analogy of a chemical bond to a spring, typically used as a model for understanding bond vibrations and infrared (IR) spectroscopy. Hooke's law states that the force F needed to elongate a spring to a distance x scales linearly with that distance x according to the equation F=kx, where k is the force constant, a constant that characterizes an individual spring's stiffness. A plot of force F versus displacement x gives a straight line with the slope k. Therefore, a stiffer spring (steeper slope, larger k) requires a force larger than that of a softer spring (flatter slope, lower k) to displace the spring at the same distance x. A stiffer spring also is more elastic and more readily returns to its original shape after deformation.

By analogy, when a polymer strand is stretched in the SMFS experiment, a stiffer strand will require more force than a more flexible strand to achieve the same elongation. The output of the SMFS experiment is a force-extension curve, and in the high-force, linear regime, a steeper slope indicates a stiffer strand. To facilitate direct comparisons of different samples, the elasticity with units of pN per unit L₀ can be determined from the slope of the linear high-force regime. The characteristic force for chain stiffness k obtained here is related to the segment elasticity (k_{seg}) of the extended freely jointed chain models of polymer elasticity by k=k_{seg}b, where b is the Kuhn length of the polymer strand.

While our first study comparing the elastic force constants of PCO and poly(trans-SiCH) provided evidence that silicon incorporation reduces the force constant of the strand, it had two limitations that the current Example will address. First, a low frequency of a poly(trans-SiCH) strand pickup during SMFS resulted in an insufficient number of pulls to assess the experimental error. Second, the requirement for a high ring strain in ROMP limited us to a single example of a polycarbooligosilane, whereas our hypothesis suggested that each additional flexible bond should lower the elastic force constant, k.

Acyclic diene metathesis (ADMET), a step-growth polymerization of linear monomers, appeared to be a promising alternative to ring-opening metathesis that would afford access to a homologous series of macromolecules with different lengths of oligosilane segments. Prior work by Wagener demonstrated that polycarbosilanes, Church et al., 2002; Matloka and Wagener, 2006, and polycarboger-manes' G6mez and Wagener, 1999, are readily obtainable by acyclic diene metathesis (FIG. 24b), which led us to hypothesize that the family of monomers (1-4) with one to four consecutive silicon atoms could afford the desired macromolecules (FIG. 24c). To the best of our knowledge, no reports of ADMET currently exist for polymers containing Si—Si bonds. We further anticipated that the postpolymerization functionalization of ADMET polymers, perhaps via epoxidation, could increase the frequency of strand pickup in the SMFS experiment by introducing polar functional groups.

### Scope

Accordingly, this Example provides the synthesis of oligosilane dienes and their corresponding ADMET polymers (FIG. 24c). In addition, we functionalized the polydienes via epoxidation to increase the rate of strand pickup during SMFS and studied the micromechanical properties of the polySiₙ-epoxides as a function of Si content via SMFS. With an increasing number of Si—Si bonds in polycarboligosilanes, we observed an overall decrease in elasticity that is in agreement with our calculations.

### Results and Discussion

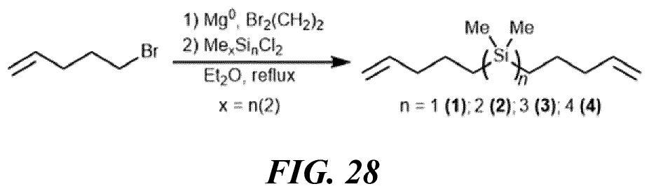

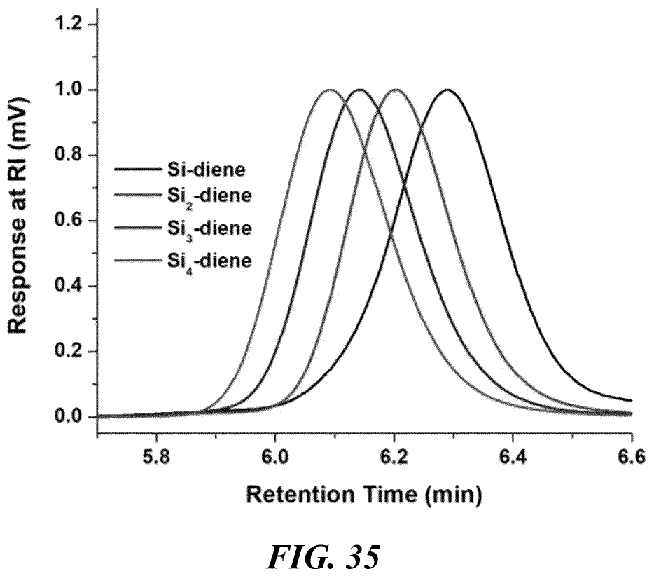

Initially, we synthesized a class of oligosilyl dienes from 5-pentenylmagnesium bromide and dichlorooligosilanes (FIG. 28). The dienes were isolated as colorless oils in 48-80% yields after rigorous purification by column chromatography, followed by vacuum distillation. Dienes 1-4 were characterized by ²⁹Si {¹H}NMR, where one [1 (2.3 ppm) and 2 (−17.9 ppm)] or two [3 (−14.1, −49.1 ppm) and 4 (−13.4, −45.0 ppm)] diagnostic silicon environments were observed to support their purity (Table 2-1). Additionally, the dienes themselves were characterized by size exclusion chromatography (SEC), and an increase in retention time with a number of silicon atoms was observed (FIG. 35).

TABLE 2-1
Observed NMR Chemical Shifts for the
²⁹Si and ¹H Nuclei in Dienes 1-4 in CDCl₃

| diene | ²⁹Si{1H} (ppm) | ¹H (ppm) [H₂C═CH—] |
|---|---|---|
| 1 | 2.3 | 5.03-4.92 (m, 4H), 5.80 (ddt, 2H) |
| 2 | −17.9 | 5.05-4.93 (m, 4H), 5.81 (ddt, 2H) |
| 3 | −14.1, −49.1 | 5.04-4.93 (m, 4H), 5.81 (ddt, 2H) |
| 4 | −13.4, −45.0 | 5.05-4.94 (m, 4H), 5.81 (ddt, 2H) |

We were then interested in polymerizing the dienes to obtain polymers with varying numbers of silicon atoms in an effort to understand the effect silicon plays on the micro-mechanical properties of the polymer chain. Due to the successful polymerization of di(4-pentenyl)dichlorosilane reported by Wagener, we chose to use Schrock's molybdenum catalyst for the ADMET polymerization. Church et al., 2002; Bazan et al., 1991; Schrock et al., 1990; Schrock, 2009.

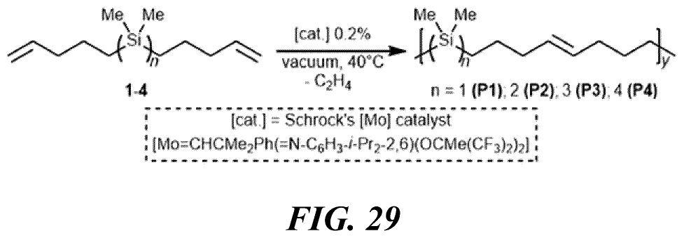

Using a monomer-to-catalyst ratio of 500:1 (0.2 mol % catalyst), Schrock's [Mo] catalyst was added to the dienes, and immediate bubbling (ethylene evolution) was observed. The polymers were stirred at room temperature under intermittent vacuum for 1 h, followed by dynamic vacuum at 40° C. for 3 days, during which the reaction solutions turned into viscous oils and stirring ceased (FIG. 29). The viscous oils were purified by precipitation into ice cold methanol to remove the [Mo] catalyst, leaving behind off-white tacky polymers (P1-P4). In some instances, the polymers remained a slight yellow-green color due to the remaining trace amounts of the Schrock catalyst that could not be separated.

P1-P4 were fully characterized by ¹H, ¹³C, and ²⁹Si NMR spectroscopy analyses, which confirmed their structures. In the ¹H NMR spectra, the disappearance of the two vinyl proton resonances and the appearance of a new broad alkene feature at 5.38 ppm were observed, confirming the release of ethylene. PolySiₙ-dienes (P1-P4) had ¹³C NMR resonances consistent with the presence of both internal cis- and trans-olefins (Table 2-2). The content of trans-alkenes was determined to be ca. 80% by quantitative ¹³C NMR studies, which was consistent with what Wagener has reported in other polyolefins obtained via ADMET. Wagener et al., 2991. No change in ²⁹Si chemical shifts was observed between the monomers and polymers.

TABLE 2-2
Molecular Weight and Stereochemical and Thermal
Properties of PolySiₙ-Dienes and PolySiₙ-Epoxides

| polymer | Mₙ (kg mol⁻¹)^{a} | M_{w}/Mₙ | % trans | T_{g} (° C.) |
|---|---|---|---|---|
| P1 | 20.3 | 2.0 | 83 | n.d.^{b} |
| P2 | 21.7 | 2.4 | 81 | −80.4 |
| P3 | 14.4 | 4.3 | 81 | −82.8 |
| P4 | 9.50 | 2.8 | 82 | −77.5 |
| P5 | 9.12 | 2.1 | 80 | −54.7 |
| P6 | 12.9 | 2.3 | 82 | −61.9 |
| P7 | 6.02 | 2.4 | 82 | −62.7 |
| P8 | 5.06 | 2.4 | 81 | −51.8 |

^{a}Molecular weight (Mₙ) was by size exclusion chromatography relative to polystyrene standards at 254 nm (THF; [polymer] = 1 mg/mL, 40° C., 0.35 mL min⁻¹, 10 μL injection).
^{b}Lower T_{g} than the limit of the instrument.

The molecular weights (Mₙ) of P1-P4 determined by size exclusion chromatography (SEC) ranged from 9500 to 21,700 g mol⁻¹, with dispersities close to 2, which is typical for polymers generated from ADMET (Table 2-2). Li et a., 2017. An exception is P3 (M_{w}/Mₙ=4.3), which we hypothesize might be due to the formation of cyclic or oligomeric byproducts that could not be separated during polymer precipitation. Given Si's tendency to lessen the ring strain relative to a carbocycle of the same number of atorns, Wakefield et al., 2023; Fang et al., 2018; Shimizu et al., 1991, the ring/chain equilibria in ADMET of Si-based polymers likely follow trends distinctive from all-carbon backbones; indeed, Wagener has characterized the significant formation of a nine-membered macrocycle (Z/E=4:1) via postpolymerization backbiting. Forbes et al., 1992; Smith and Wagener, 1993. Attempts to conclusively identify cyclic or oligomeric species by MALDI-TOF mass spectrometry, however, were not conclusive due to the challenges in ionization.

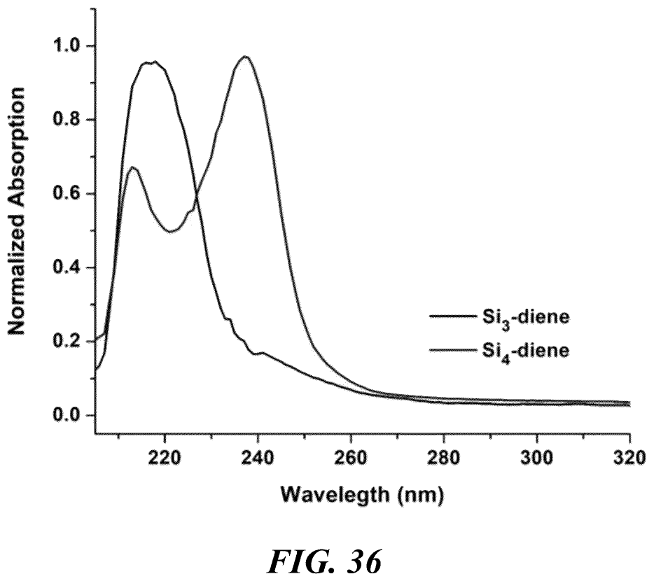

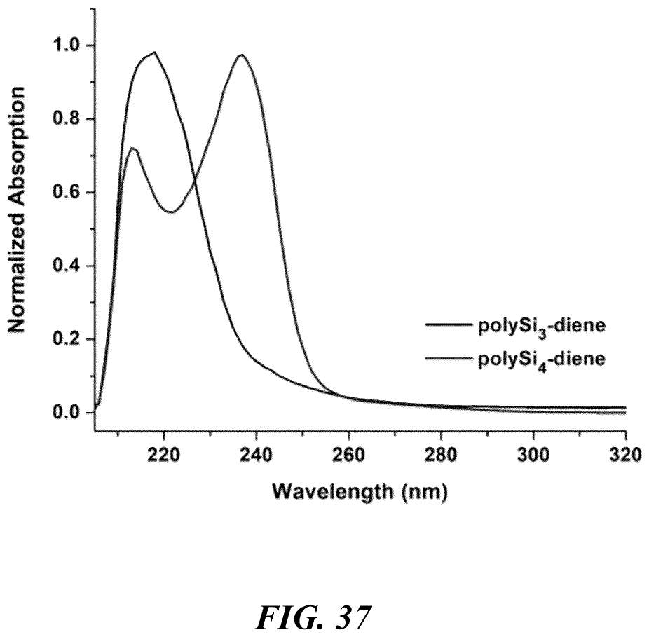

We attribute the decrease in the molecular weight from P2 to P4 to uncontrollable differences in experimental conditions when the viscosity of the polymers caused a significant decrease in the stirring rate. UV-vis studies of P3 and P4 in THF solutions revealed absorption maxima at 216 and 236 nm, FIG. 36 and FIG. 37, respectively, which are consistent with the photophysical properties of 3, 4, and previously reported oligosilanes. Tamao et al., 2000; Tsuji et al., 2003; Gilman and Atwell, 1965; Gilman et al., 1964; Fukazawa et al., 2006. The mono- and disilane moieties of P1 and P2 were expected to absorb high-energy UV light (<200 nm) outside the window of our spectrophotometer (Me₃SiSiMe₃ λₘₐₓ=197.5 nm), Gilman et al., 1964, and therefore UV-vis spectra for these samples were not obtained.

Without wishing to be bound to any one particular theory, it was thought that the olefin moieties of isolated P1-P4 could be epoxidized to facilitate our ability to study their mechanical properties via SMFS, as has been done previously with other main-chain olefins. Bowser et al., 2021; Horst et al., 2021; Wang et al., 2022. To ensure that the Si—Si bonds within the polymer backbone were stable to the strong oxidizing conditions of epoxidation, we first explored the reaction of 3 and meta-chloroperoxybenzoic acid (mCPBA). A DCM solution of mCPBA was added to a cooled solution of 3 in DCM and slowly warmed to room temperature over 20 h.

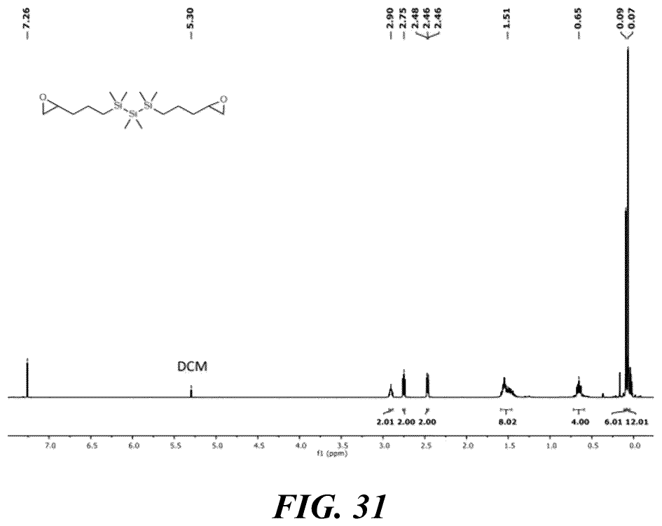

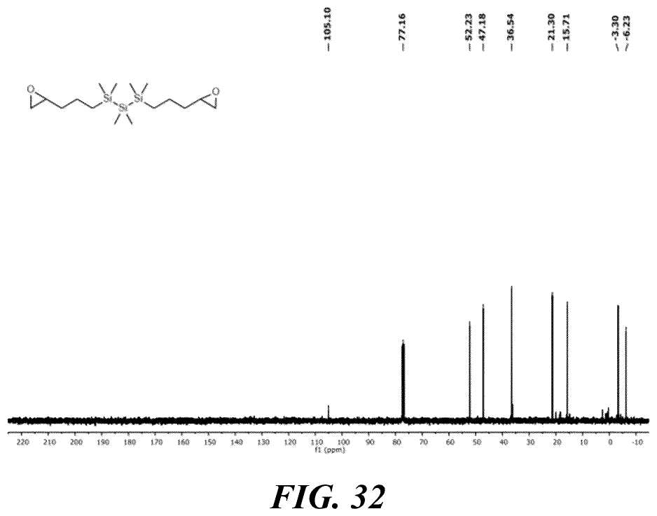

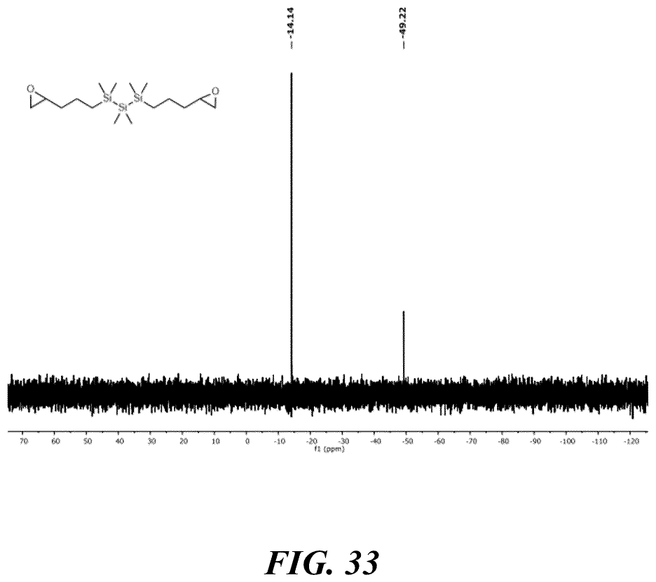

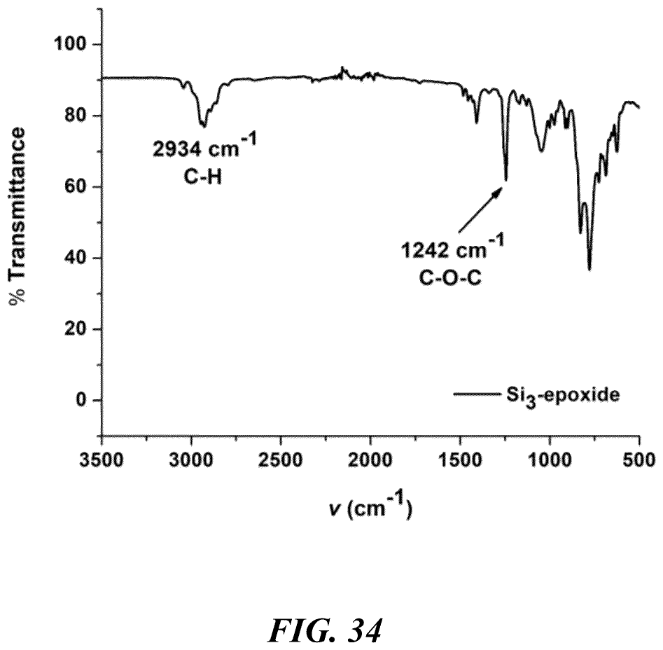

Analysis by ¹H NMR spectroscopy of the unpurified reaction mixture showed only 3-chlorbenzoic acid and signals consistent with the di-epoxy. After the basic aqueous workup to remove the benzoic acid, the ¹H NMR spectrum showed the disappearance of the alkene proton resonances and the appearance of three new resonances between 2.46 and 2.90 ppm. These new peaks are consistent with previous reports of a similar alkoxide-substituted silacyclobutane, Matsumoto et al., 2016, and main-chain epoxides, Bradbury et al., 1985; Matic et al., 2020, and are therefore assigned as such. Further, no evidence of oxygen insertion into the Si—Si bonds or silicon bond cleavage was observed via ¹H NMR and IR analyses (FIG. 31, FIG. 32, FIG. 33, and FIG. 34).

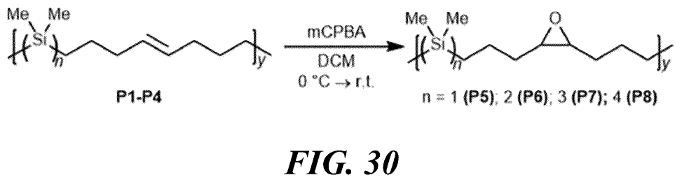

Using the same conditions for the epoxidation of 3, the new functionalized polymers (P5-P8) were isolated as colorless, viscous liquids in 62-96% yields (FIG. 30). A nearly 50% decrease in molecular weight is observed via SEC when comparing the polySiₙ-dienes to polySiₙ-epoxides, which could be associated with the difference in the hydrodynamic volume once the alkenes are functionalized with the epoxide units. The polySiₙ-epoxides were characterized structurally in solution by ¹H, ¹³C, and ²⁹Si NMR spectroscopy analyses. Both the ¹H and ¹³C NMR spectra displayed resonances attributed to the presence of cis- and trans-epoxides on the polymer chains.

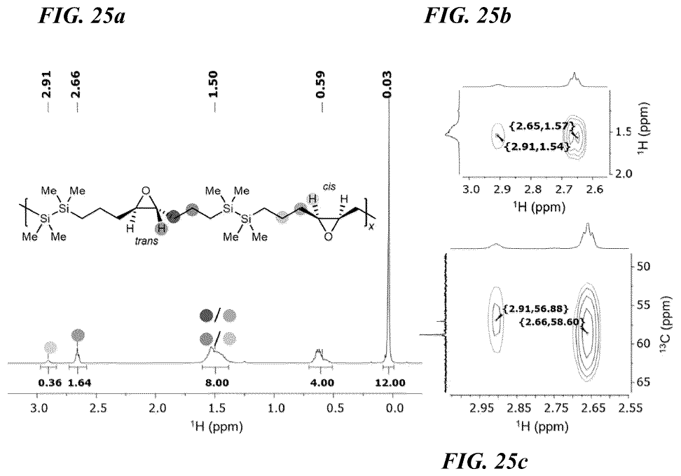

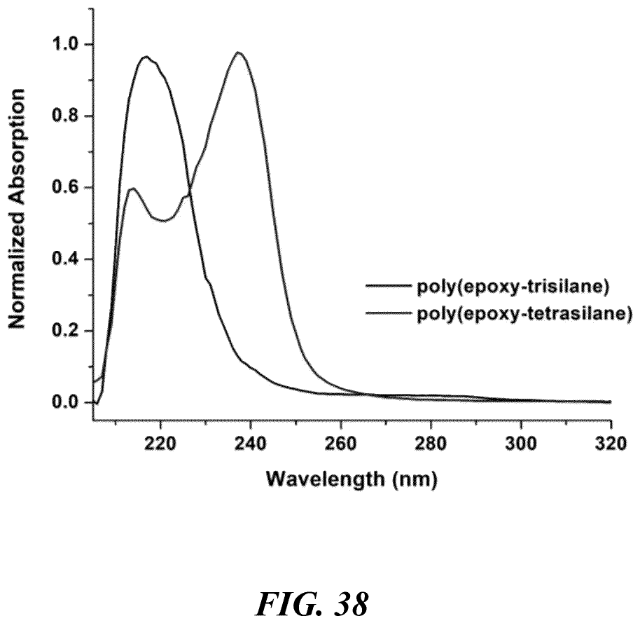

For example, in the ¹H NMR spectrum of P6, chemical shifts at 2.91 and 2.66 ppm are assigned to the cis- and trans-epoxide protons, respectively (FIG. 25a). Additional ¹H-¹H homonuclear correlation spectroscopy (COSY) shows cross-peaks between the cis- and trans-epoxide protons and neighboring CH₂ (1.56 ppm) (FIG. 25b), ¹H-¹³C heteronuclear single-quantum correlation spectroscopy (HSQC) allows the cis- and trans-carbon environments to be assigned due to the observed cross-peak between the cis-proton resonance at 2.91 ppm and the carbon resonance at 57.0 ppm (FIG. 25c. The cis/trans ratio after epoxidation (18:82) is in agreement with the cis/trans ratio of the starting polySiₙ-diene (19:81) (Table 2-2). The absorption maxima for P7 (215 nm) and P8 (237 nm) are in agreement with those of P3 and P4 and support the absence of Si—O—Si units within the polymer strands (FIG. 38).

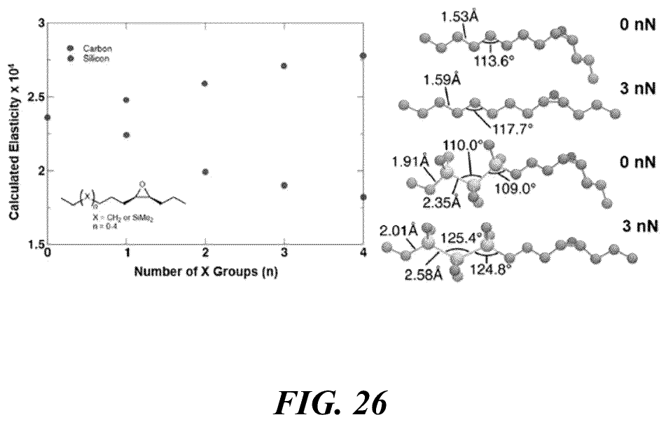

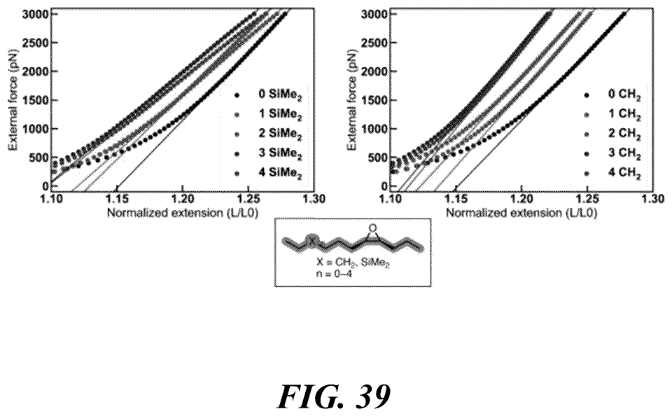

The thermal properties of polymers P1-P8 were studied via differential scanning calorimetry (DSC) and thermogravimetric analysis (TGA). Given the well-known pyrolysis of polycarbosilanes and polysilanes to silicon carbide, under an inert atmosphere, Birot et al., 1995; Yajima et al., 1978, and the thermal decomposition of polysilanes, typically beginning around 200-250° C., we obtained air-free TGA data on P1-P4 to determine the onset temperature for decomposition. Notably, P2-P8 exhibit low glass-transition temperatures (T_{g}), which we attribute to the high degree of flexibility within the polymer chains and the small pendent groups on silicon. This observation is in contrast to our previous study, wherein poly(trans-SiCH) has a significantly higher T_{g} of 39.7° C. due to the presence of bulkier Ph substituents. The T_{g} value of P1 is below the limit of the DSC instrument employed (−90° C.), which is in agreement with the polycarbosilane previously reported by Wagener. Church et al., 2002. Additionally, an overall trend of higher T_{g}values for the polySiₙ-epoxides was observed in comparison to those of the polySiₙ-dienes. We attribute this trend to the increased interchain interactions arising from the more polar epoxy groups that could reduce the overall free volume and increase T_{g}. Again, without wishing to be bound to any one particular theory, it was thought that the high-force elasticity of the polymer could be modulated by the number of silicon atoms along the polymer strand. To test this hypothesis, we carried out a DFT study of epoxidized monomer units capped by methyl groups, where the amount of dimethylsilene or methylene groups was varied (FIG. 26). The structures of these compounds were optimized under an external pulling force using the external force is explicitly included (EFEI) formalism, Ribas-Arino et al., 2009, where the force was applied to the terminal methyl groups in increments of 50 pN, ranging from force-free conditions to 3000 pN. We observed that silicon-silicon and silicon-carbon bonds tended to distort more under an external force. Similarly, we found that bond angles around silicon atoms tend to distort along the strand more easily compared to the bond angles around carbon atoms. For example, at 3 nN, a LC—C—C bond angle distorted by 4.10 relative to the optimized structure at 0 nN, while a similarly situated LSi-Si—Si bond angle was distorted by 15.4°. The monomer elasticity was calculated by determining the slope of the force-extension curves of the terminal methyl groups of monomers in linear regions from 1.5 to 3.0 nN. The monomer lengths were normalized by the distance between the two terminal methyl groups optimized under force-free conditions (FIG. 39).

Consistent with our hypothesis, we found that by increasing the amount of dimethylsilene, the elasticity of the monomer decreases gradually with each additional Si atom along the strand, from 2.36 to 1.82×10⁴ pN per unit L₀, whereas similar effects are not observed by incorporating additional methylene groups in the monomer strand (FIG. 26).

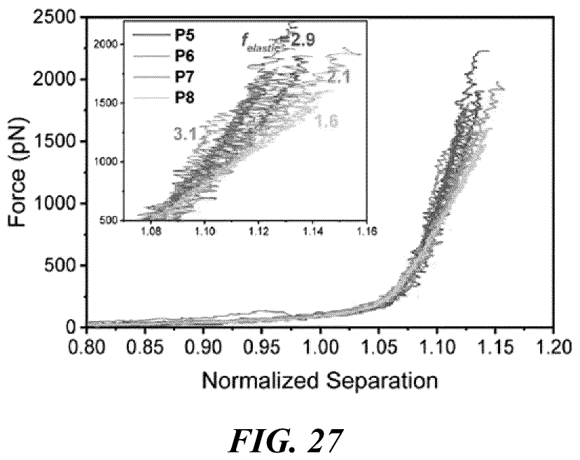

To further analyze the force-coupled behaviors of the polymers, we performed SMFS experiments on P5-P8. Achieving attachments that persist to high (˜nN) forces is difficult for nonpolar and unreactive polymers such as P1-P4, but the combination of silicon AFM probes and epoxide functionality in P5-P8 resulted in a sufficient number of pulling events to obtain statistically meaningful data about the relative single-chain mechanics. Each force-separation curve was first fit with a modified freely jointed chain model to determine the contour length (L₀) of the polymer subchain that was trapped between the cantilever tip of the AFM system and the surface on which the substrate was adsorbed. The separation for each curve was then normalized to the length of its unit contour as L/L₀ (FIG. 27). To quantitatively evaluate the impact of increasing Si atoms on the chain elasticity, the slopes of force-extension curves (f_{elastic}) in the enthalpic distortion region from 1000 pN to Fₘₐₓ at which the polymer detaches from the cantilever (analysis is limited to curves in which Fₘₐₓ>1500 pN) were compared across the series P5-P8 (Table 2-3),

TABLE 2-3
Slopes of the High-Force Region (F >
1000 pN) of the Force-Extension Curves of P5-P8

| Polymer | f_{elastic} (pN × 10⁴ per unit L₀) |
|---|---|
| Polycyclooctene | 3.5 ± 0.1 |
| P5 | 2.9 ± 0.3 |
| P6 | 3.1 ± 0.3 |
| P7 | 2.1 ± 0.3 |
| P8 | 1.6 ± 0.4 |

The values of f_{elastic} have an experimental uncertainty of 15-25% across the series, which we attribute to the low molecular weights of the polymers. The characterization of short polymer strands is complicated by greater contributions from off-angle pulling, Ke et al., 2007; Rivera et al., 2008, and greater relative errors from uncertainty in the spatial measurement. Nonetheless, the data are broadly consistent with the computational predictions. First, f_{elastic} of all of the polymers (1.6-3.4×10⁴ pN per unit L₀) is lower than that of the carbon-based polymer polycyclooctene (3.5×10⁴ pN per unit L₀). Wakefield et al., 2023.

Second, the measured f_{elastic} is greater for the low Si content polymers P5 and P6 (2.9×10⁴ and 3.1×10⁴ pN/L₀, respectively) than for the higher Si content polymers P7 and P8 (2.1×10⁴ and 1.6×10⁴ pN/L₀, respectively). This variation in force constant corresponds to an increase of 9-33% in Si atom content per repeat unit. While P5 does not have an fₑiaₛₜic value higher than that of P6-P8 as expected, it is the only polymer without Si— Si bonds, and due to its lower molecular weight, achieving a higher number of pulling events from SMFS to produce a statistical difference proved to be difficult.

The overall reduction in f_{elastic} with the increasing Si content suggests an opportunity to tune the chain extension behavior through subtle variations in the monomer design in a way that can eventually be used to probe the connection between the micromechanical properties of single strands and the properties of polymer networks made from those polymers. Furthermore, P5-P8 had higher elasticity than our previously reported poly(trans-SiCH) (1.4×10⁴ pN/L₀) with a silicon incorporation of 43%, which is in agreement with the calculated trends. Wakefield et al., 2023.

### SUMMARY

In summary, this Example provides the preparation of a new class of oligosilane dienes and their ADMET polymers. The poly-(carbooligosilane)s were characterized in solution via NMR, which revealed polymer chains with a high percent of internal trans-olefins. DFT studies supported our hypothesis of polymer elasticity decreasing with an increasing number of Si—Si bonds. Functionalization of the ADMET polymers with epoxide groups allowed us to experimentally investigate the elastic properties via SMFS, which was in agreement with the same trend. These data suggest that substitution of carbon with silicon in linear polymers will have a substantial effect on the mechanical properties of materials.

### Example 3

### Isomer-Driven Polymerization, Depolymerization, and Reconstruction

### Overview

This Example demonstrates that differences in ring strain enthalpy between cis and trans isomers of sila-cycloheptene provide a driving force for both polymerization and depolymerization via olefin metathesis. A need for new methods to reintroduce the low-strain isomer into the plastic economy inspired the development of a polymerization based on ring-opening/cross-metathesis step polymerization, which afforded perfect sequence control for an alternating copolymer. The chemical principles are a platform for achieving both efficient polymerization and depolymerization with high mass recovery in functional polymers.

### BACKGROUND

Chemical solutions to end-of-life management of post-consumer plastic waste are an emerging and urgent area of research. Fagnani et al., 2021. Currently, less than 10% of plastic waste is mechanically recycled, instead ending in the landfill or incinerator (a linear plastic economy). In contrast to mechanical recycling, which can erode material properties due to changes in molecular weight characteristics arising from mechanical degradation, chemical recycling to monomer transforms plastic waste into feedstocks indistinguishable from petroleum-derived monomer, which can then reform pristine plastics (a more circular plastic economy). Coates and Getzler, 2020. Approaches to chemical recycling to monomer include comonomers or end groups in poly(methyl methacrylate) (PMMA) that trigger β-scission, Young et al., 2023; Hughes et al., 2024; Martinez et al., 2021; Wang et al., 2022; Chin et al., 2024; Whitfield et al., 2023; Bellotti et al., 2023, transesterification of poly(ethylene terephthalate), George and Kurian, 2014; Tang et al., 2019; Wang et al., 2024; Delle Chiaie et al., 2020, self-immolative polymers, Lutz et al., 2019; Yuan et al., 2021; Hansen-Felby et al., 2022, and more. Gallin et al., 2023.

Olefin metathesis-based approaches to polymer deconstruction have been recently reviewed. Sathe et al., 2024. An attractive feature of this approach is that the polymer is stable until addition of the metathesis catalyst. Deconstruction can be a depolymerization process that returns the original starting monomer or a reaction yielding a different chemical building block.

Conk et al., 2022. Polymerization thermodynamics are critical: Ols6n et al., 2016; Zhou et al., 2022; Zhang et al., 2024, if ring-opening metathesis polymerization (ROMP) is highly exothermic due to significant strain release, the reverse reaction (ring-closing metathesis (RCM) depolymerization) is challenging to effect. Chemical recycling to monomer by olefin metathesis was until recently limited to monomers with low-to-moderate ring strain, Neary and Kennemur, 2019, while polymeric materials derived from higher strain monomers like norbornene and cis-cyclooctene, Martinez et al., 2014, were not depolymerizable to monomer. Recently, structural modifications to cis-cyclooctene enabled chemical recycling to monomer by modulating ring-strain enthalpy (RSE) and polymerization-depolymerization thermodynamics. Zhou et al., 2022; Sathe et al., 2021.

Exploiting the differences in RSE between cis and trans geometric isomers of the same cycloalkene has potential to broaden the scope of polymeric materials amenable to olefin metathesis polymerization-depolymerization, as shown by Wang et al. in a “closed-loop” photoisomerization-ROMP-RCM cycle of fused bicyclic cyclooctene monomers. Chen et al., 2021.

However, olefin photoisomerization has limitations: high-energy light is typically needed (e.g., 254 nm) and the amount of cis isomer that can be converted to trans isomer is fundamentally limited by the photostationary trans:cis ratio. This means that not all the chemical matter recovered by depolymerization to the cis-isomer can reenter the cycle, highlighting the need for additional chemical methods to reintroduce the low-strain isomer into the plastic economy.

In this Example, we demonstrate isomer-driven polymerization, depolymerization, and reconstruction of sila-cycloheptene by multiple olefin metathesis mechanisms. We recently reported the geometrically-selective synthesis of both the cis and trans isomers of sila-cycloheptene 1 in which trans-1 was high strain (ca. 10 kcal mol⁻¹) and readily underwent ROMP. Wakefield et al., 2023. P1 is a novel example of a hybrid polymer incorporating both C and Si into the backbone. We showed via single molecule force spectroscopy that the Si incorporation into P1 reduced single chain elasticity relative to all-carbon polymer backbones, resulting in a softer, less stiff polymer strand, which was hypothesized to arise from force-induced changes in geometry and conformation at Si. Wentz et al., 2023. While trans-1 was a good ROMP monomer, low strain cis-1 (ca. 1-2 kcal mol⁻¹) did not polymerize. DFT calculations predicted that metathesis initiation is kinetically accessible for cis-1, but ROMP is endothermic.

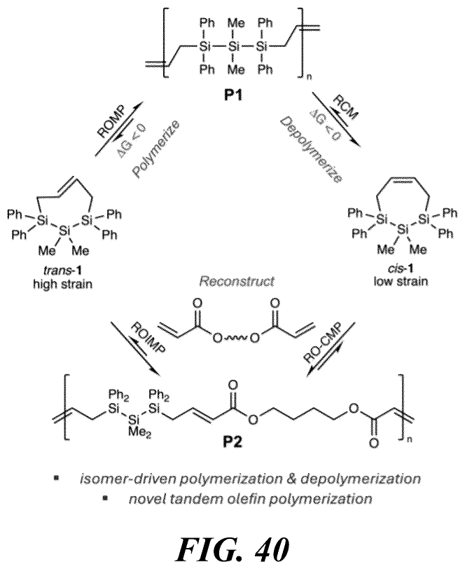

We now report well-controlled ROMP of trans-1 to afford a high molecular weight (>300 kg mol⁻¹) homopolymer P1 that is stable in the absence of a metathesis initiator but undergoes 100% depolymerization to low-strain cis-1 upon addition of an appropriate initiator (FIG. 40). To reuse the low-strain isomer, without wishing to be bound to any one particular theory that ring-opened cis-1 could be captured in a selective cross-metathesis reaction, resulting in a novel tandem ring-opening/cross-metathesis (RO-CM) olefin metathesis polymerization that is sequence-controlled. We show that recovered cis-1 participates in RO-CM with butanediol diacrylate (BDA) to afford a perfectly alternating copolymer P2. This work demonstrates the ability of isomerism to drive novel polymer design, optimize reactivity, mass recovery, and reuse, as well as the role of Si for C replacement, Wakefield et al., 2024, in modulating monomer ring strain, polymerization thermodynamics, and polymer properties.

### Results and Discussion

Our initial efforts focused on identifying if molecular weight characteristics are important in depolymerization of P1 as our initial publication reported a high molecular weight and high dispersity polymer (Mn=62.6 kg mol⁻¹, Mw/Mn=3.50) reflecting a multimodal sample containing both high molecular weight strands and oligomeric fragments. Wakefield et al., 2023.

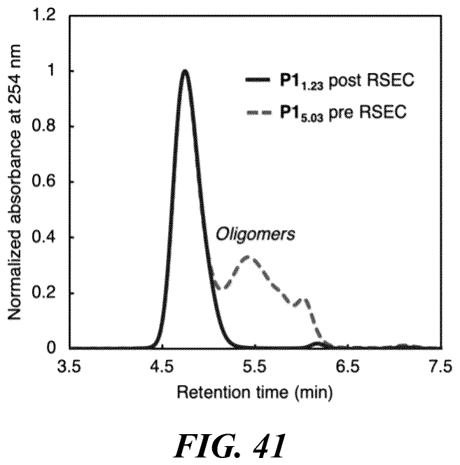

The low molecular weight fraction included cyclic oligomers arising from ring-closing macrocyclization, which lack end groups and could complicate end-group selective initiation of depolymerization. To remove the lower molecular weight fraction, trans-1 was polymerized to P1_{5.03} as a polymodal sample then purified via recycling size exclusion chromatography (RSEC) and reprecipitated in methanol to afford narrow dispersity P1_{1.23} (FIG. 41).

Unimodal P1 can also be synthesized directly, as we have now also identified improved ROMP conditions. Hypothesizing that the formation of lower molecular weight oligomers arose from secondary metathesis reactions, we sought to rigorously purify trans-1 by recrystallization to remove any olefinic contaminants from synthesis (e.g., trans-1,4-dichlorobutene). With highly purified starting material and a much shorter reaction time of 10 minutes, P1 was synthesized in high molecular weight and in a unimodal distribution (Mₙ=92.9 kg mol⁻¹, M_{w}/Mₙ=1.14, Scheme

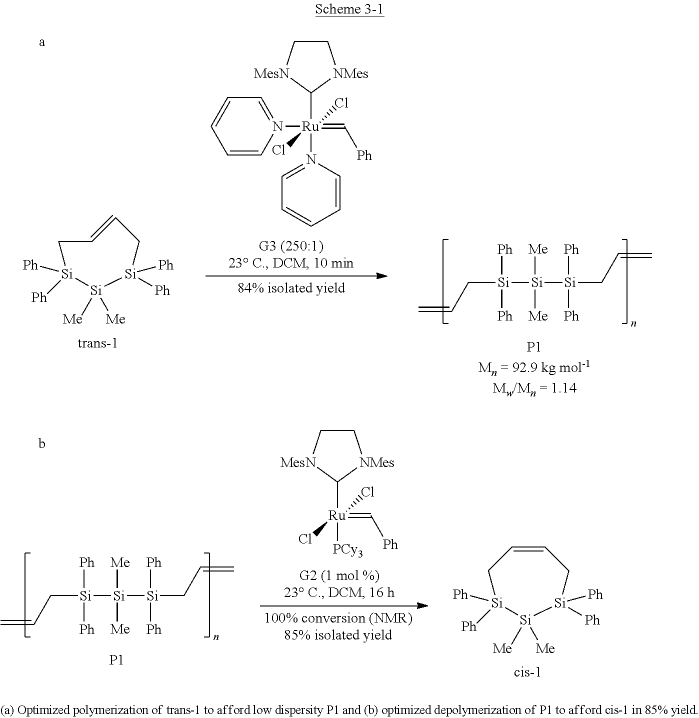

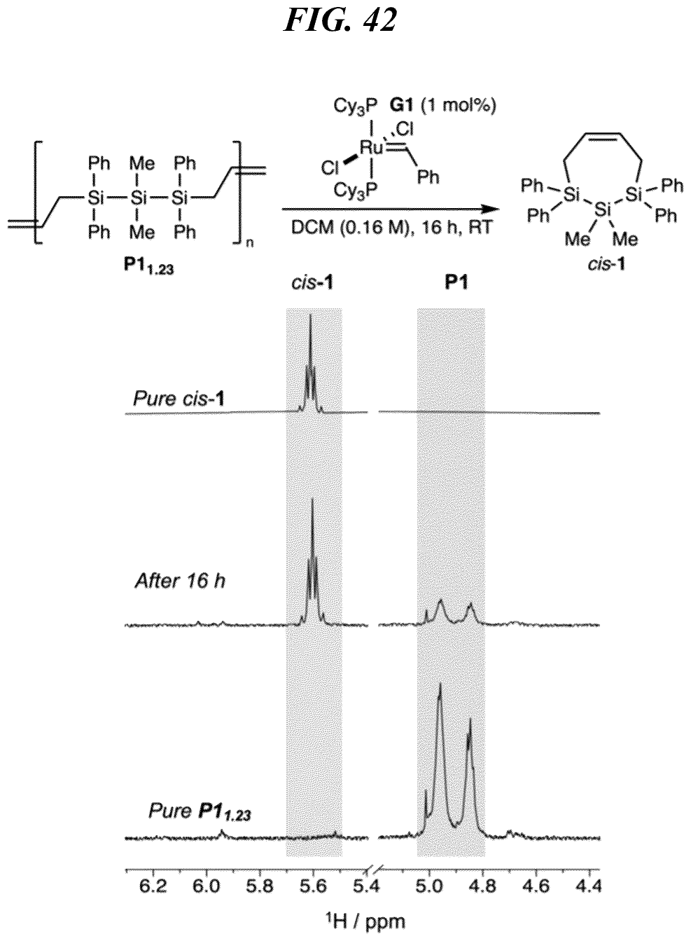

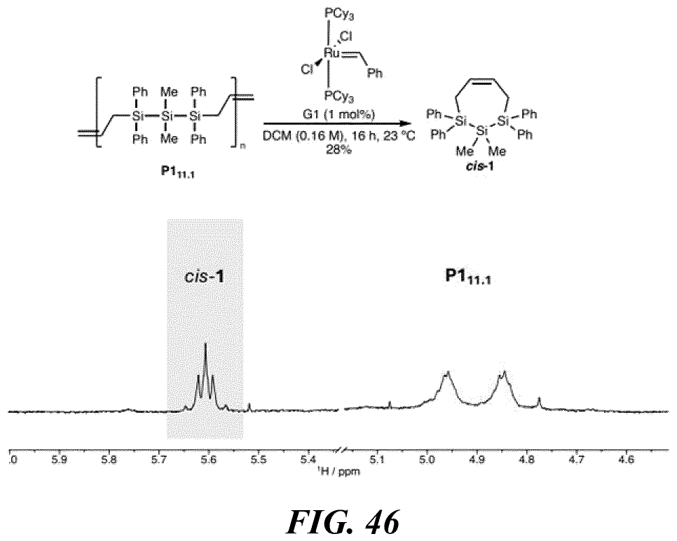

Upon treatment of P1_{1.23} with 1 mol % of the metathesis initiator G1, we observed after 16 hours by ¹H NMR spectroscopy the growth of peaks assigned to cis-1 (55% conversion) with polymeric material remaining (FIG. 42). Consistent with chain transfer competing with depolymerization by RCM, multimodal P1_{11.1} (containing residual oligomers) depolymerized in only 28% conversion under the same conditions (FIG. 46).

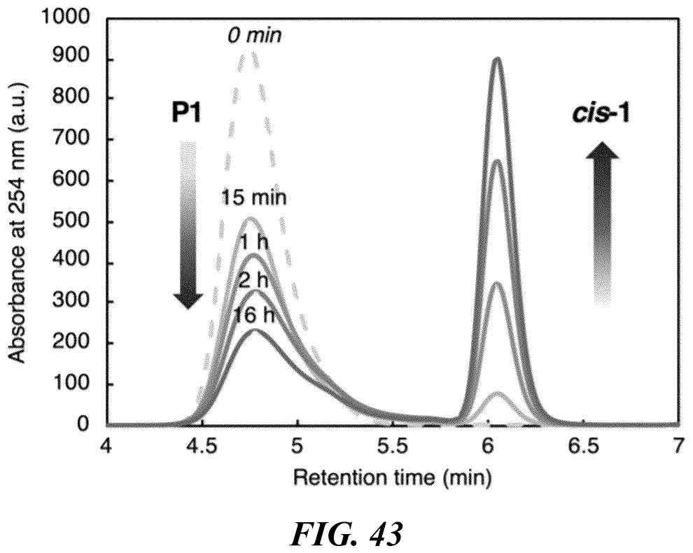

Monitoring the depolymerization of P1_{1.23} over time by SEC (FIG. 43 and Table 3-1), we observed a gradual decrease in the amount of P1 and an increase in cis-1. Reisolation of P1 at each time point showed that Mₙ decreased from 11.9 kg mol⁻¹ to 6.92 kg mol⁻¹ while dispersity increased modestly from 1.30 to 1.81 (Table 3-1). Deconstruction at random internal sites would result in many more short oligomers and a much broader M_{w}/Mₙ than we observed here, suggesting a possible end-to-end depolymerization. At the same time, the modest increase in dispersity suggested that chain transfer might also be occurring between strands, reducing the efficiency of depolymerization.

TABLE 3-1
Molecular weight characteristics of recovered P1 over time^{a}

| Reaction time | Mₙ ^{b} (kg mol⁻¹) | M_{w}/Mₙ ^{b} |
|---|---|---|
| 0 | 11.9 | 1.30 |

| | | | |
|---|---|---|---|
| 15 | min | 9.55 | 1.51 |
| 1 | h | 8.0 | 1.68 |
| 2 | h | 7.12 | 1.79 |
| 16 | h | 6.92 | 1.81 |

^{a}Depolymerization of P1 performed at room temperature over 16 h with a concentration of 0.16M in DCM and 1 mol % G1.
^{b} Determined by size exclusion chromatography relative to polystyrene standards at 254 nm (THF, [P1] = 0.75 mg mL⁻¹, 40° C., 0.35 mL min⁻¹, 10 μL injection).

We investigated other metathesis initiators. While G3 improved the depolymerization efficiency compared to G1, resulting in 86% depolymerization of P1 to cis-1, the best conditions employed 1 mol % of G2 and increased depolymerization efficiency to 100% conversion to cis-1 (Table 3-2), entries 2 and 3), with no remaining high molecular weight polymer. In general, higher loadings of metathesis promoter and higher temperatures led to higher quantities of recovered cis-1 (entries 5-7). Scaling up the best conditions, we were able to depolymerize 80 mg of P1 to 100% conversion by ¹H NMR and with 85% isolated yield of cis-1 (Table 3-2), entry 3). Without wishing to be bound to any one theory, it is thought that the higher depolymerization efficiency with G2 is related to its generally higher reactivity relative to G1, Scholl et al., 1999, and employing G2 instead of G1 also increased the depolymerization efficiency of high dispersity material (compare entries 5 and 9).

TABLE 3-2
Conversion of P1 to cis-1 under different conditions

| | M w/Mn of | | | | % NMR |
|---|---|---|---|---|---|
| Entry | starting P1 | Cat.^{a} | mol % | Temp. (° C.) | yield^{b} cis-1 |
| 1 | 1.23 | G1 | 1 | 23 | 55 |
| 2 | 1.23 | G2 | 1 | 23 | 100 |
| 3 | 2.13 | G2 | 1 | 23 | 100 (85% |
| | | | | | isolate yield) |
| 4 | 1.23 | G3 | 1 | 23 | 86 |
| 5 | 11.1 | G1 | 1 | 23 | 28 |
| 6 | 11.1 | G1 | 3 | 23 | 38 |
| 7 | 11.1 | G1 | 5 | 23 | 37 |
| 8 | 11.1 | G1 | 1 | 50 | 36 |
| 9 | 8.61 | G2 | 1 | 23 | 84 |

^{a}Catalyst used for depolymerization.
^{b}Determined from the relative integration of the polymer olefinic protons and the olefinic protons of cis-1.

Having identified the circumstances leading to complete depolymerization of P1 to cis-1, we considered potential reuse scenarios for this low-strain cycloalkene. Entropy-driven ROMP can be an effective method for polymerization of low-strain cycloalkenes but requires high concentrations, Pearce et al., 2019, and cis-1 is a crystalline solid that is poorly soluble in CH₂Cl₂, CHCl₃ and other solvents (Table 3-3). We considered alkene photoisomerization, but photochemical silylene extrusion, Moiseev and Leigh, 2006, is possible for cis-1. In addition, the amount of trans isomer available from the cis isomer is limited by the photostationary trans cis ratio. Hammond and Saltiel, 1962; Inoue et al., 1985.

TABLE 3-3
Maximum concentration of cis-1 in organic solvents.

| | Amount | Solvent | Concentration of |
|---|---|---|---|
| Solvent | cis-1 (mg) | Added (mL) | dilution (M) |
| Dioxane | 16.1 | 1.20 | 0.0028 |
| CHCl₃ | 16.2 | 0.190 | 0.178 |
| Toluene | 20.9 | 0.900 | 0.048 |
| THF | 18.6 | 0.260 | 0.150 |

For these reasons, we sought an alternative polymerization method for cis-1. Prior calculated free energy profiles for initiation of cis- and trans-1 ROMP with G2, Wakefield et al., 2023, indicated that cis-1 is kinetically able to form a ring-opened, Ru-terminated structure similar to A (FIG. 6). Chatterjee et al., 2003.

While the reaction of A with cis-1 to form a homopolymer via ROMP (a chain polymerization) is endothermic and not observed, without wishing to be bound to any one particular theory that intermediate A could instead be captured in cross-metathesis. Reaction of A with a bifunctional Type 2 olefin B₂ would release the metathesis catalyst and difunctional molecule AB, which we anticipated would be a suitable step polymerization monomer, Odian, 2004, via selective cross-metathesis between terminal alkene and acrylate end groups. Montero et al., 2011; Gorodetskaya et al., 2007.

Formation of the low energy α,β-unsaturated ester provides the driving force for ring-opening/cross-metathesis (RO-CM). While RO-CM is a tandem reaction extensively developed for small molecule synthesis, Morgan et al., 2002; Randall et al., 1995, it does not appear that RO-CM step polymerization has previously been reported. The polymerization by selective cross-metathesis of linear monomers with a terminal alkene and an acrylate supports our hypothesized mechanism. Montero et al., 2011; Gorodetshaya et al., 2007.

It is plausible that both RO-CM and the reverse order of fundamental steps (cross metathesis/ring-opening, CM-RO) operate simultaneously, although CM-RO would require G2 to react first with B₂ and then ring open cis-1, Ulman et al., 2000; Choi et al., 2001, while the reaction of G2 with acrylates is slower than with more activated olefins.

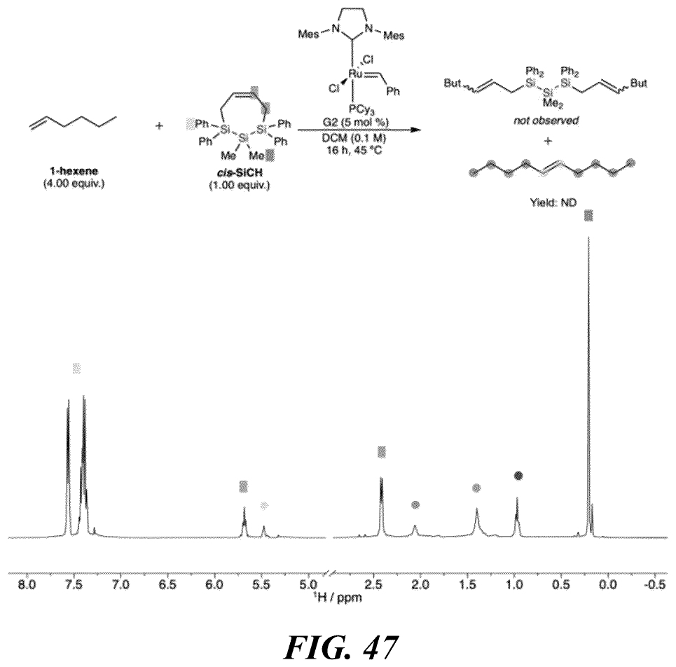

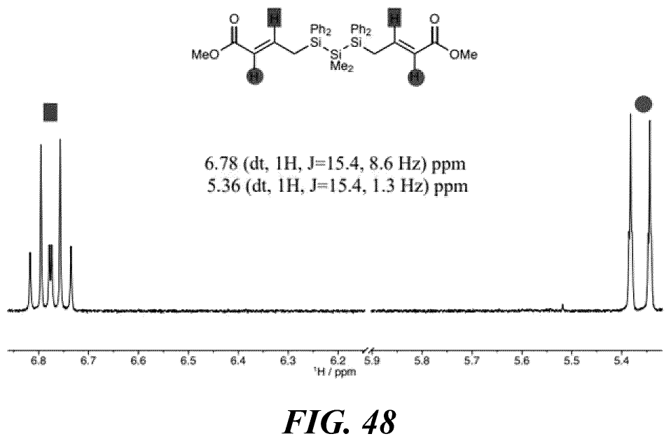

To test the hypothesized RO-CM reactivity, we carried out two small molecule studies in which we reacted cis-1 with 1-hexene (Type 1 olefin) or methyl acrylate (Type 2 olefin). With 1-hexene, we only observed the formation of the homodimerization product 4-decene and residual cis-1 (FIG. 47). But in the presence of excess methyl acrylate, the ring-opened structure 2 was isolated in 61% yield after purification by silica gel chromatography (Scheme 3-2). The RO-CM product 2 has exclusively the trans olefin geometry, as determined by the coupling constants of the olefinic peaks δ 6.81 (J_{1H-1H}=15.5 Hz) and δ 5.39 (J_{1H-1H}=15.4 Hz) (FIG. 48).

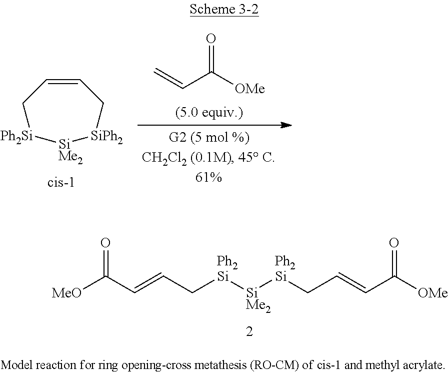

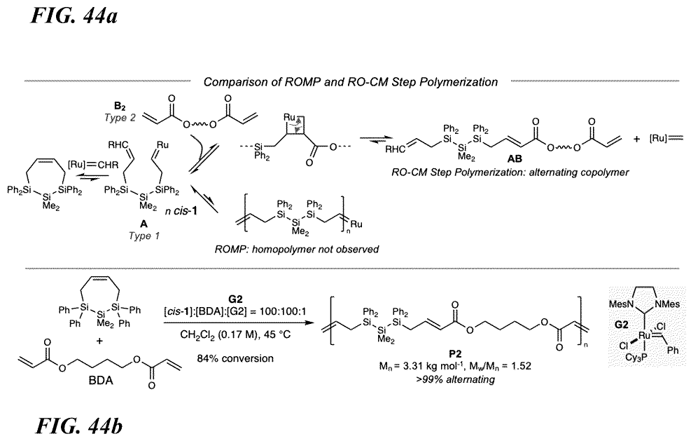

Expanding from molecular RO-CM, we then investigated the RO-CM step polymerization of cis-1 and 1,4-butanediol diacrylate (BDA) (FIG. 44b). We observed 91% consumption of cis-1 within 4.5 hours. By precipitation from hexanes, we obtained polymer P2 (Mₙ=3.31 kg mol⁻¹, M_{w}/Mₙ=1.87). Structural characterization supported incorporation of both monomers. ATR-IR spectroscopy (FIG. 48) indicated the presence of an α,β-unsaturated carbonyl at 1706 cm⁻¹, as well as a SiMe functional group at 1257 cm⁻¹.

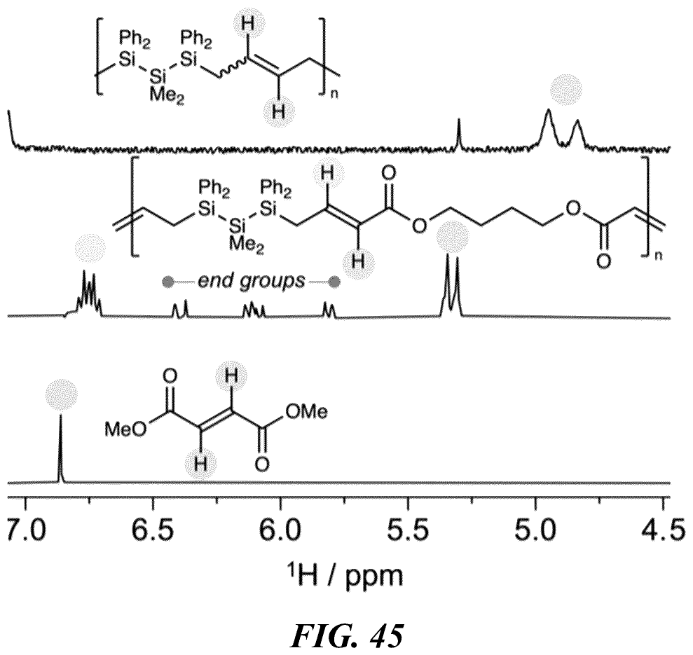

Since cis-1 is a poor ROMP monomer and BDA is a poor ADMET monomer, RO-CM predicts an alternating copolymer due to faster crosspolymerization than homopolymerization. Structural characterization supported assignment of P2 to a highly alternating polymer (>99% alteration) based on ¹H NMR spectroscopy (FIG. 45) in which neither the singlet consistent with a fumarate resonance nor the lower field resonances of a diallyl silane were observed. The major peaks were assigned to the alternating copolymer and were consistent with an (E)-geometry. Resonances consistent with both acrylate and styrenic end groups were identified and full details of copolymer structural characterization are reported in the ESI. We note that P2 can itself be deconstructed at end of life by ester hydrolysis.

To understand the impact of BDA incorporation onto the properties of a hybrid carbosilane polymer, we measured the glass transition temperature (T_{g}) of P2. While the homopolymer P1 exhibits a glass transition temperature a little above room temperature (ca. 35° C.), the alternating copolymer P2 had a T_{g}ca. 13° C. The lower T_{g} may reflect the additional incorporation of the flexible butane chain and a lower overall aromatic side chain content. In recent years, the role of sequence control has emerged as a tactic for modulating the glass transition temperature of a copolymer. Choi et al., 2001. The onset of thermal decomposition occurred at ca. 300° C., consistent with other Si—Si containing polymers. Wakefield et al., 2023; Drayer and Simmons, 2022.

This tandem ring-opening and selective cross-metathesis polymerization has the advantage of very high sequence control, a grand challenge in polymer synthesis. Lutz et al., 2023; Li and Li, 2018. The copolymerization of cycloalkenes and α,ω-diene monomers related to Type 1 olefins is known, but not sequence controlled. Si and Chen, 2022; Si et al., 2024.

Alternating copolymerization by olefin metathesis has been reported with cyclohexene and electron-poor strained cycloalkenes (e.g., cyclobutenecarboxamide). Parker and Sampson, 2016.

The most similar reaction to ours is ring-opening-insertion metathesis polymerization (ROIMP). ROIMP is the copolymerization of cycloalkenes and diacrylates to yield highly alternant copolymers, Choi et al., 2002; Lee et al., 2015; Chauveau et al., 2019, Chauveau et al., 2020, but ROIMP proceeds by a distinctly different mechanism involving first rapid cycloalkene ROMP (e.g., cis-cyclooctene), followed by insertion of BDA or other diacrylate into the homopolymer by a slower secondary metathesis process.

In the current work, the lack of cis-1 homopolymerization and the well-precedented slow rate of acrylate dimerization are not consistent with a ROIMP mechanism involving insertion of a second monomer into a homopolymer. A series of control experiments suggested that cis-1/BDA RO-CM copolymerization proceeds by a mechanism that is distinct from ROIMP and that these differences result in meaningful impacts on polymer microstructure e.g., sequence control.

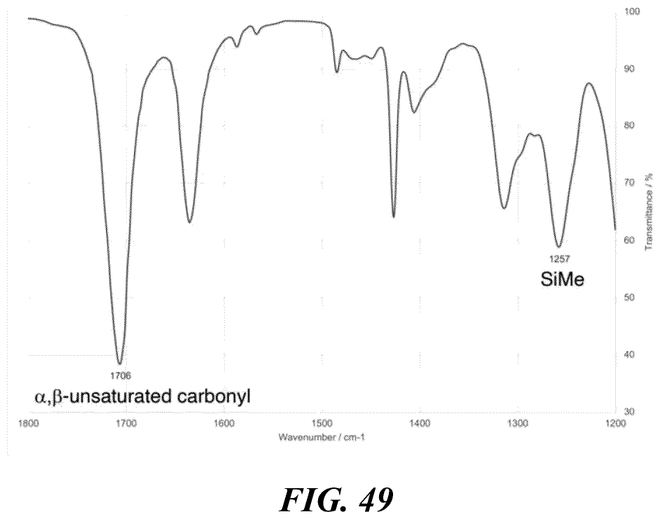

First, we evaluated the reactivity of trans-1 and BDA under the same conditions employed for cis-1. We observed a mixture that consisted predominantly of P1 and unreacted BDA, with evidence of smaller amounts of dimeric BDA and P2 (FIG. 49). This is distinctly different from the outcome with cis-1, where no homopolymers were observed, and is consistent with high strain trans-1 being suitable for ROIMP while low strain cis-1 reacts via RO-CM step polymerization.

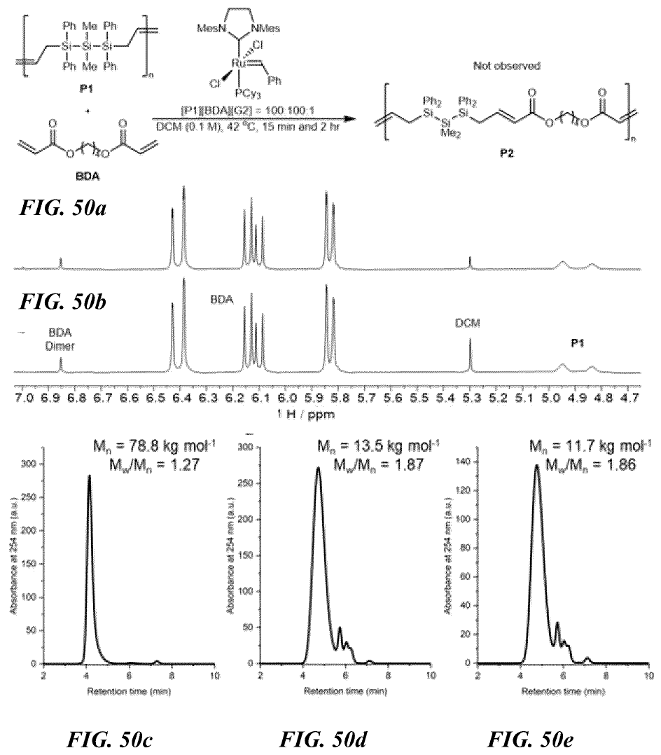

Second, we noted that Choi and Grubbs reported that polycyclooctene could be used directly as a substrate for ROIMP, supporting the hypothesis that the homopolymer is an intermediate. If ROIMP was operative for the copolymerization of cis-1/BDA, P1 should react with BDA to yield P2. However, the reaction between homopolymer P1 and BDA afforded only residual P1 and small quantities of the BDA dimer/oligomer, but no spectroscopic evidence of either cis-1 or P2 (FIG. 50).

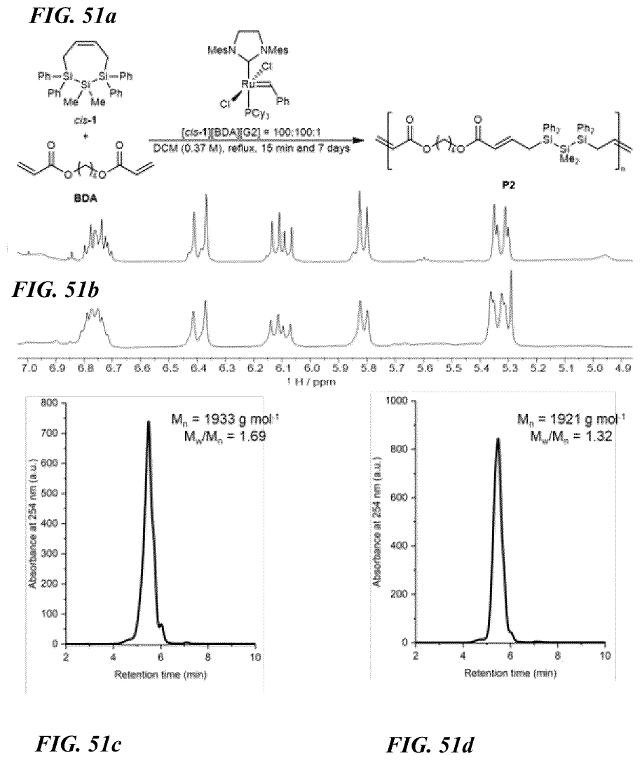

Third, a consequence of the ROIMP mechanism is that extended homopolycycloalkene segments were found at early time points (e.g., 20 min). Choi et al., 2002. For cis-1/BDA copolymerization, high alternation of 82.0% was observed after 15 minutes (FIG. 51). This points to the very high selectivity for cross-metathesis rather than homopolymerization.

### SUMMARY

The isomer-driven metathesis reactivity reported herein highlights how subtle differences in structure, thermodynamics, and kinetics can be exploited in the well-controlled, serial polymerization/depolymerization/reconstruction pathways. Only the trans isomer of sila-cycloheptene 1 undergoes ROMP by chain polymerization, driven by strain release. The reverse ring-closing metathesis reaction yields only the low-strain cis isomer of 1, driven by the entropic benefit of depolymerization, and leading to 100% selectivity for a single product and 100% conversion in chemical recycling. The use of cycloalkene geometric isomerism to affect the position of polymer thermodynamics is recently emerging, building onto the use of cis/trans relative configuration at tetrahedral stereoegenic centers. Shan et al., 2024; Smith et al., 2023.

We reintroduce cis-1 into polymeric materials by a novel tandem olefin metathesis pathway involving ring-opening/cross-metathesis step polymerization. Tandem olefin metathesis reactions remain rare in macromolecular synthesis due to poor control, Lee et al., 2015, but herein we achieved perfect selectivity for the cross-metathesis reaction and obtained a highly alternant copolymer from cis-1 and the diacrylate BDA. The resulting polymer was fully characterized by ATR-IR, ¹H, ¹³C, ²⁹Si, COSY, and HSQC NMR spectroscopy to determine polymer microstructure.

That a 7-membered ring can switch from a high to a low-strain reactivity manifold is enabled not only by controlling olefin geometry, but also by the ability of Si for C replacement to modulate ring conformation and geometry (trans-cycloheptene is unstable >-40° C.). Squillacote et al., 2005. This Example demonstrates that subtle structural modifications can have dramatic effects on chemical reactivity relevant to polymer end-of-life management.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents form part of the common general knowledge in the art.
Abd-El-Aziz, A. S. Organometallic Polymers of the Transition Metals. Macromol. Rapid Commun. 2002, 23 (17), 995-1031.
Albinsson, B.; Teramae, H.; Downing, J. W.; Michl, J. Conformers of Saturated Chains: Matrix Isolation, Structure, IR and UV Spectra of n-Si 4 Me 10. Chem.—A Eur. J. 1996, 2, 529-538.
Alonso-Villanueva, J.; Cuevas, J. M.; Laza, J. M.; Vilas, J. L.; Le6n, L. M. Synthesis of Poly(Cyclooctene) by Ring-Opening Metathesis Polymerization: Characterization and Shape Memory Properties. J. Appl. Polym. Sci. 2010, 115, 2440-2447.
Barroso, G.; Li, Q.; Bordia, R. K.; Motz, G. Polymeric and Ceramic Silicon-Based Coatings-a Review. J. Mater. Chem. A 2019, 7, 1936-1963.
Barrows, S. E.; Eberlein, T. H. Cis and Trans Isomers of Cycloalkenes. J. Chem. Educ. 2005, 82, 1334-1339.
Bazan, G. C.; Oskam, J. H.; Cho, H. N.; Park, L. Y.; Schrock, R. R. Living ring-opening metathesis polymerization of 2,3-difunction-alized 7-oxanorbornenes and 7-oxanorbornadienes by Mo—(CHCMe₂R)(NC₆H₃-iso-Pr₂-2,6)(O-tert-Bu)₂ and Mo—(CHCMe₂R)(NC₆H₃-iso-Pr₂-2,6)(OCMe₂CF₃)₂. J. Am. Chem. Soc. 1991, 113 (18), 6899-6907.
Bellotti, V., K. Parkatzidis, H. S. Wang, N. De Alwis Watuthanthrige, M. Orfano, A. Monguzzi, N. P. Truong, R. Simonutti and A. Anastasaki, Polym. Chem., 2023, 14, 253-258.
Bielawski, C. W.; Grubbs, R. H. Increasing the Initiation Efficiency of Ruthenium-Based Ring-Opening Metathesis Initiators: Effect of Excess Phosphine. Macromolecules 2001, 34, 8838-8840.
Binder, J. L. The Infrared Spectra and Structures of Polybutadienes. J. Polym. Sci. Part A Gen. Pap. 1963, 1, 47-58.
Binnig, G.; Quate, C. F.; Gerber, C. Atomic Force Microscope. Phys. Rev. Lett. 1986, 56, 930-933.
Birot, M.; Pillot, J.-P.; Dunogues, J. Comprehensive Chemistry of Polycarbosilanes, Polysilazanes, and Polycarbosilazanes as Precursors of Ceramics. Chem. Rev. 1995, 95 (5), 1443-1477.
Blinka, T. A.; Helmer, B. J.; West, R. Polarization Transfer NMR Spectroscopy for Silicon-29: The INEPT and DEPT Techniques. In Advances in Organometallic Chemistry, 1984; Vol. 23, pp 193-218.
Bowser, B. H.; Wang, S.; Kouznetsova, T. B.; Beech, H. K.; Olsen, B. D.; Rubinstein, M.; Craig, S. L. Single-Event Spectroscopy and Unravelling Kinetics of Covalent Domains Based on Cyclobutane Mechanophores. J. Am. Chem. Soc. 2021, 143 (13), 5269-5276.
Bradbury, J. H.; Perera, M. C. S. Epoxidation of natural rubber studied by nmr spectroscopy. J. Appl. Polym. Sci. 1985, 30 (8), 3347-3364.
Brzezinska, K. R.; Schitter, R.; Wagener, K. B. Carbosilane/Carbosiloxane-Based ADMET Homopolymers and Copolymers Possessing Latent Reactivity. J. Polym. Sci., Part A: Polym. Chem. 2000, 38, 1544-1550.
Carraher, C. E., Jr. Organometallic polymers. J. Chem. Educ. 1981, 58 (11), 921.
Caseri, W. Polystannanes: processible molecular metals with defined chemical structures. Chem. Soc. Rev. 2016, 45 (19), 5187-5199.
Chatterjee, A. K., T.-L. Choi, D. P. Sanders and R. H. Grubbs, J. Am. Chem. Soc., 2003, 125, 11360-11370.
Chauveau, C., S. Fouquay, G. Michaud, F. Simon, J.-F. Carpentier and S. M. Guillaume, ACS Appl. Polym. Mater., 2019, 1, 1540-1546.
Chauveau, C., S. Fouquay, G. Michaud, F. Simon, J.-F. Carpentier and S. M. Guillaume, ACS Appl. Polym. Mater., 2020, 2, 5135-5146.
Chen, H.; Shi, Z.; Hsu, T.; Wang, J. Overcoming the Low Driving Force in Forming Depolymerizable Polymers through Monomer Isomerization. Angew. Chem., Int. Ed. 2021, 60, 25493-25498.
Chin, M. T., T. Yang, K. P. Quirion, C. Lian, P. Liu, J. He and T. Diao, J. Am. Chem. Soc., 2024, 146, 5786-5792.
Choi, T.-L., C. W. Lee, A. K. Chatterjee and R. H. Grubbs, J. Am. Chem. Soc., 2001, 123, 10417-10418.
Choi, T.-L., I. M. Rutenberg and R. H. Grubbs, Angew. Chem., 2002, 114, 3995-3997.
Church, A. C.; Pawlow, J. H.; Wagener, K. B. Synthesis of Functionalized Polycarbosilanes via One-Pot ADMET Polymerization-Macromolecular Substitution. Macromolecules 2002, 35 (15), 5746-5751.
Coates, G. W., and Y. D. Y. L. Getzler, Nat. Rev. Mater., 2020, 5, 501-516.
Conk, R. J., S. Hanna, J. X. Shi, J. Yang, N. R. Ciccia, L. Qi, B. J. Bloomer, S. Heuvel, T. Wills, J. Su, A. T. Bell and J. F. Hartwig, Science, 2022, 377, 1561-1566.
Cushman, K.; Keith, A.; Tanaka, J.; Sheiko, S. S.; You, W. Investigating the Stress-Strain Behavior in Ring-Opening Metathesis Polymerization-Based Brush Elastomers. Macromolecules 2021, 54, 8365-8371.
Delle Chiaie, K. R., F. R. McMahon, E. J. Williams, M. J. Price and A. P. Dove, Polym. Chem., 2020, 11, 1450-1453.
Drayer, W. F., and D. S. Simmons, Macromolecules, 2022, 55, 5926-5937.
Duan, C.; Cai, W.; Huang, F.; Zhang, J.; Wang, M.; Yang, T.; Zhong, C.; Gong, X.; Cao, Y. Novel Silafluorene-Based Conjugated Polymers with Pendant Acceptor Groups for High Performance Solar Cells. Macromolecules 2010, 43 (12), 5262-5268.
Evans, E. A.; Ritchie, K. Strength of a Weak Bond Connecting Flexible Polymer Chains. Biophys. J. 1999, 76, 2439-2447.
Fagnani, D. E., J. L. Tami, G. Copley, M. N. Clemons, Y. D. Y. L. Getzler and A. J. McNeil, ACS Macro Lett., 2021, 10, 41-53.
Fang, Y.; Zhang, H.; Huang, Z.; Scinto, S. L.; Yang, J. C.; am Ende; Christopher, W.; Dmitrenko, O.; Johnson, D. S.; Fox, J. M. Photochemical syntheses, transformations, and bioorthogonal chemistry of trans-cycloheptene and sila trans-cycloheptene Ag(i) complexes. Chem. Sci. 2018, 9 (7), 1953-1963.
Fischer, R.; Frank, D.; Gaderbauer, W.; Kayser, C.; Mechtler, C.; Baumgartner, J.; Marschner, C. α,ω-Oligosilyl Dianions and Their Application in the Synthesis of Homo- and Heterocyclosilanes. Organometallics 2003, 22, 3723-3731.
Forbes, M. D. E.; Patton, J. T.; Myers, T. L.; Maynard, H. D.; Smith, D. W., Jr.; Schulz, G. R.; Wagener, K. B. Solvent-free cyclization of linear dienes using olefin metathesis and the Thorpe-Ingold effect. J. Am. Chem. Soc. 1992, 114 (27), 10978-10980.
Fukazawa, A.; Tsuji, H.; Tamao, K. All-anti-Octasilane: Conformation Control of Silicon Chains Using the Bicyclic Trisilane as a Building Block. J. Am. Chem. Soc. 2006, 128 (21), 6800-6801.
Gallin, C. F., W. Lee and J. A. Byers, Angew. Chem., Int. Ed., 2023, 62, e202303762.
George, N., and T. Kurian, Ind. Eng. Chem. Res., 2014, 53, 14185-14198.
Gilman, H.; Atwell, W. H. The ultraviolet properties of some perphenylated linear and cyclic polysilanes. J. Organomet. Chem. 1965, 4 (2), 176-178.
Gilman, H.; Atwell, W. H.; Schwebke, G. L. Ultraviolet properties of compounds containing the silicon-silicon bond. J. Organomet. Chem. 1964, 2 (4), 369-371.
Gömez, F. J.; Wagener, K. B. Germanium-containing polymers via acyclic diene metathesis. J. Organomet. Chem. 1999, 592 (2), 271-277.
Gorodetskaya, I. A., T.-L. Choi and R. H. Grubbs, J. Am. Chem. Soc., 2007, 129, 12672-12673.
Gupta, R. R.; Lechner, M. D. Chemical Shifts and Coupling Constants for Silicon-29; Springer: Dordrecht, The Netherlands, 2008; Vol. 35F.
Hammond, G. S., and J. Saltiel, J. Am. Chem. Soc., 1962, 84, 4983-4984.
Hansen-Felby, M., A. Sommerfeldt, M. L. Henriksen, S. U. Pedersen and K. Daasbjerg, Polym. Chem., 2022, 13, 85-90.
Hejl, A.; Scherman, O. A.; Grubbs, R. H. Ring-Opening Metathesis Polymerization of Functionalized Low-Strain Monomers with Ruthenium-Based Catalysts. Macromolecules 2005, 38, 7214-7218.
Hlil, A. R.; Balogh, J.; Moncho, S.; Su, H.-L.; Tuba, R.; Brothers, E. N.; Al-Hashimi, M.; Bazzi, H. S. Ring Opening Metathesis Polymerization (ROMP) of Five- to Eight-Membered Cyclic Olefins: Computational, Thermodynamic, and Experimental Approach. J. Polym. Sci., Part A: Polym. Chem. 2017, 55, 3137-3145.
Hoffmann, R.; Inoue, Y. Trapped Optically Active (E)-Cycloheptene Generated by Enantiodifferentiating Z-E Photoisomerization of Cycloheptene Sensitized by Chiral Aromatic Esters. J. Am. Chem. Soc. 1999, 121, 10702-10710.
Horst, M.; Yang, J.; Meisner, J.; Kouznetsova, T. B.; Martinez, T. J.; Craig, S. L.; Xia, Y. Understanding the Mechanochemistry of Ladder-Type Cyclobutane Mechanophores by Single Molecule Force Spectroscopy. J. Am. Chem. Soc. 2021, 143 (31), 12328-12334.
Hughes, R. W., M. E. Lott, I. S. Zastrow, J. B. Young, T. Maity and B. S. Sumerlin, J. Am. Chem. Soc., 2024, 146, 6217-6224.
Husted, K. E. L.; Shieh, P.; Lundberg, D. J.; Kristufek, S. L.; Johnson, J. A. Molecularly Designed Additives for Chemically Deconstructable Thermosets without Compromised Thermomechanical Properties. ACS Macro Lett. 2021, 10, 805-810.
Inoue, Y., T. Kobata and T. Hakushi, J. Phys. Chem., 1985, 89, 1973-1976.
Jiang, Q.; Gittens, A. F.; Wong, S.; Siegler, M. A.; Klausen, R. S. Highly selective addition of cyclosilanes to alkynes enabling new conjugated materials. Chem. Sci. 2022, 13 (25), 7587-7593.
Jiang, Q.; Wong, S.; Klausen, R. S. Effect of Polycyclosilane Microstructure on Thermal Properties. Polym. Chem. 2021, 12, 4785-4794.
Johnson, A. M.; Husted, K. E. L.; Kilgallon, L. J.; Johnson, J. A. Orthogonally Deconstructable and Depolymerizable Polysilylethers via Entropy-Driven Ring-Opening Metathesis Polymerization. Chem. Commun. 2022, 58, 8496-8499.
Jones, R. G.; Budnik, U.; Holder, S. J.; Wong, W. K. C. Reappraisal of the Origins of the Polymodal Molecular Mass Distributions in the Formation of Poly(Methylphenylsilylene) by the Wurtz Reductive-Coupling Reaction. Macromolecules 1996, 29, 8036-8046.
Katz, S. M.; Reichl, J. A.; Berry, D. H. Catalytic Synthesis of Poly(arylmethylgermanes) by Demethanative Coupling: A Mild Route to σ-Conjugated Polymers. J. Am. Chem. Soc. 1998, 120 (38), 9844-9849.
Kayser, C.; Kickelbick, G.; Marschner, C. Simple Synthesis of Oligosilyl-α,ω-Dipotassium Compounds. Angew. Chem., Int. Ed. 2002, 41, 989-992.
Ke, C.; Jiang, Y.; Rivera, M.; Clark, R. L.; Marszalek, P. E. Pulling Geometry-Induced Errors in Single Molecule Force Spectroscopy Measurements. Biophys. J. 2007, 92 (9), L76-L78.
Klausen, R. S.; Ballestero-Martinez, E. Organosilicon and Related Group 14 Polymers. In Comprehensive Organometallic Chemistry IV, Parkin, G.; Meyer, K.; O'Hare, D., Eds.; Elsevier, 2022; pp 135-165.
Krebs, A.; Pforr, K.-I.; Raffay, W.; Thölke, B.; König, W. A.; Hardt, I.; Boese, R. A Stable Hetero-Trans-Cyclopentene. Angew. Chem. Int. Ed. Engl. 1997, 36, 159-160.
Kumar, V. B.; Leitao, E. M. Properties and applications of polysilanes. Appl. Organomet. Chem. 2020, 34 (3), No. e5402.
Kunai, A.; Ueda, T.; Horata, K.; Toyoda, E.; Nagamoto, I.; Ohshita, J.; Ishikawa, M.; Tanaka, K. Polymeric Organosilicon Systems. 26. Synthesis and Photochemical and Conducting Properties of Poly[(tetraethyldisilanylene)oligo(2,5-thienylenes)]. Organometallics 1996, 15 (8), 2000-2008.
Lee, H.-K., K.-T. Bang, A. Hess, R. H. Grubbs and T.-L. Choi, J. Am. Chem. Soc., 2015, 137, 9262-9265.
Li, H.; Caire da Silva, L.; Schulz, M. D.; Rojas, G.; Wagener, K. B. A review of how to do an acyclic diene metathesis reaction. Polym. Int. 2017, 66 (1), 7-12.
Li, H.; Zhang, W.; Xu, W.; Zhang, X. Hydrogen Bonding Governs the Elastic Properties of Poly(Vinyl Alcohol) in Water: Single-Molecule Force Spectroscopic Studies of PVA by AFM. Macromolecules 2000, 33, 465-469.
Li, Z., and Z. Li, in Sequence-Controlled Polymers, ed. J. Lutz, Wiley, 1st edn, 2018, pp. 349-377.
Luo, Z.; Zhang, A.; Chen, Y.; Shen, Z.; Cui, S. How Big Is Big Enough?Effect of Length and Shape of Side Chains on the Single-Chain Enthalpic Elasticity of a Macromolecule. Macromolecules 2016, 49, 3559-3565.
Lutz, J. P., O. Davydovich, M. D. Hannigan, J. S. Moore, P. M. Zimmerman and A. J. McNeil, J. Am. Chem. Soc., 2019, 141, 14544-14548.
Lutz, J.-F., M. Ouchi, D. R. Liu and M. Sawamoto, Science, 2013, 341, 1238149.
Manners, I. Polymers and the Periodic Table: Recent Developments in Inorganic Polymer Science. Angew. Chem., Int. Ed. Engl. 1996, 35 (15), 1602-1621.
Mark, J. E. Silicon-Containing Polymers. In Silicon-Based Polymer Science, American Chemical Society, 1989; pp 47-68.
Markov, J.; Fischer, R.; Wagner, H.; Noormofidi, N.; Baumgartner, J.; Marschner, C. Open, Cyclic, and Bicyclic Compounds of Double Silylated Phosphorus and Boron. Dalt. Trans. 2004, 51, 2166.
Marro, E. A.; Folster, C. P.; Press, E. M.; Im, H.; Ferguson, J. T.; Siegler, M. A.; Klausen, R. S. Stereocontrolled Syntheses of Functionalized Cis- and Trans-Siladecalins. J. Am. Chem. Soc. 2019, 141, 17926-17936.
Marro, E. A.; Klausen, R. S. Conjugated Polymers Inspired by Crystalline Silicon. Chem.
Mater. 2019, 31, 2202-2211.
Marro, E. A.; Press, E. M.; Purkait, T. K.; Jimenez, D.; Siegler, M. A.; Klausen, R. S. Cooperative Noncovalent Interactions Induce Ion Pair Separation in Diphenylsilanides. Chem.—A Eur. J. 2017, 23, 15633-15637.
Marro, E. A.; Press, E. M.; Siegler, M. A.; Klausen, R. S. Directional Building Blocks Determine Linear and Cyclic Silicon Architectures. J. Am. Chem. Soc. 2018, 140, 5976-5986.
Marszalek, P. E.; Oberhauser, A. F.; Pang, Y. P.; Fernandez, J. M. Polysaccharide Elasticity Governed by Chair-Boat Transitions of the Glucopyranose Ring. Nature 1998, 396, 661-664.
Martinez, H., N. Ren, M. E. Matta and M. A. Hillmyer, Polym. Chem., 2014, 5, 3507.
Martinez, M. R., S. Dadashi-Silab, F. Lorandi, Y. Zhao and K. Matyjaszewski, Macromolecules, 2021, 54, 5526-5538.
Matic, A.; Hess, A.; Schanzenbach, D.; Schlaad, H. Epoxidized 1,4-polymyrcene. Polym. Chem. 2020, 11 (7), 1364-1368.
Matloka, P. P.; Wagener, K. B. The acyclic diene metathesis (ADMET) polymerization approach to silicon containing materials. J. Mol. Catal. A: Chem. 2006, 257 (1), 89-98.
Matsumoto, K.; Kakehashi, M.; Ouchi, H.; Yuasa, M.; Endo, T. Synthesis and Properties of Polycarbosilanes Having 5-Membered Cyclic Carbonate Groups as Solid Polymer Electrolytes. Macromolecules 2016, 49 (24), 9441-9448.
McQuade, J.; Serrano, M. I.; Jäkle, F. Main Group Functionalized Polymers through Ring-Opening Metathesis Polymer¬ization (ROMP). Polymer 2022, 246, No. 124739.
Michl, J.; West, R. Conformations of Linear Chains. Systematics and Suggestions for Nomenclature. Ace. Chem. Res. 2000, 33, 821-823.
Miller, R. D.; Michl, J. Polysilane High Polymers. Chem. Rev. 1989, 89, 1359-1410.
Moiseev, A. G., and W. J. Leigh, J. Am. Chem. Soc., 2006, 128, 14442-14443.
Montero De Espinosa, L., and M. A. R. Meier, Chem. Commun., 2011, 47, 1908-1910.
Morgan, J. P., C. Morrill and R. H. Grubbs, Org. Lett., 2002, 4, 67-70.
Neary, W. J.; Kennemur, J. G. Polypentenamer Renaissance: Challenges and Opportunities. ACS Macro Lett. 2019, 8, 46-56.
Neveself, T.; Wienhold, M.; Molloy, J. J.; Gilmour, R. Advances in the e→Z Isomerization of Alkenes Using Small Molecule Photocatalysts. Chem. Rev. 2022, 122, 2650-2694.
Odian, G., Principles of polymerization, J. Wiley & sons, Hoboken (N.J.), 4th edn, 2004.
Ohshita, J.; Takata, A.; Kai, H.; Kunai, A.; Komaguchi, K.; Shiotani, M.; Adachi, A.; Sakamaki, K.; Okita, K.; Harima, Y.; Kunugi, Y.; Yamashita, K.; Ishikawa, M. Synthesis of Polymers with Alternating Organosilanylene and Oligothienylene Units and Their Optical, Conducting, and Hole-Transporting Properties. Organo-metallics 2000, 19 (22), 4492-4498.
Olsën, P., K. Odelius and A.-C. Albertsson, Biomacromolecules, 2016, 17, 699-709.
Parker, K. A., and N. S. Sampson, Acc. Chem. Res., 2016, 49, 408-417.
Pearce, A. K.; Foster, J. C.; O'Reilly, R. K. Recent Developments in Entropy-driven Ring-opening Metathesis Polymerization: Mechanistic Considerations, Unique Functionality, and Sequence Control. J. Polym. Sci., Part A: Polym. Chem. 2019, 57, 1621-1634.
Power, P. P. An Update on Multiple Bonding between Heavier Main Group Elements: The Importance of Pauli Repulsion, Charge-Shift Character, and London Dispersion Force Effects. Organo-metallics 2020, 39 (23), 4127-4138.
Power, P. P. Homonuclear multiple bonding in heavier main group elements. J. Am. Chem. Soc., Dalton Trans. 1998, 18, 2939-2951.
Press, E. M.; Marro, E. A.; Surampudi, S. K.; Siegler, M. A.; Tang, J. A.; Klausen, R. S. Synthesis of a Fragment of Crystalline Silicon: Poly(Cyclosilane). Angew. Chem., Int. Ed. 2017, 56, 568-572.
Priegert, A. M.; Rawe, B. W.; Serin, S. C.; Gates, D. P. Polymers and the p-block elements. Chem. Soc. Rev. 2016, 45 (4), 922-953.
Purkait, T. K.; Press, E. M.; Marro, E. A.; Siegler, M. A.; Klausen, R. S. Low-Energy Electronic Transition in SiB Rings. Organometallics 2019, 38, 1688-1698.
Randall, M. L., J. A. Tallarico and M. L. Snapper, J. Am. Chem. Soc., 1995, 117, 9610-9611.
Ratushnyy, M.; Zhukhovitskiy, A. V. Polymer Skeletal Editing via Anionic Brook Rearrangements. J. Am. Chem. Soc. 2021, 143, 17931-17936.
Ribas-Arino, J.; Shiga, M.; Marx, D. Understanding Covalent Mechanochemistry. Angew. Chem., Int. Ed. 2009, 48 (23), 4190-4193.
Rivera, M.; Lee, W.; Ke, C.; Marszalek, P. E.; Cole, D. G.; Clark, R. L. Minimizing Pulling Geometry Errors in Atomic Force Microscope Single Molecule Force Spectroscopy. Biophys. J. 2008, 95 (8), 3991-3998.
Rosenberg, L. Exploiting Catalytic Dehydrogenative Coupling in the Synthesis and Study of Polysilanes. Macromol. Symp. 2003, 196, 347-353.
Rylski, A. K.; Cater, H. L.; Mason, K. S.; Allen, M. J.; Arrowood, A. J.; Freeman, B. D.; Sanoja, G. E.; Page, Z. A. Polymeric Multimaterials by Photochemical Patterning of Crystallinity. Science 2022, 378, 211-215.
Sanzone, J. R.; Woerpel, K. A. High Reactivity of Strained Seven-Membered-Ring Trans-Alkenes. Angew. Chem., Int. Ed. 2016, 55, 790-793.
Sathe, D., S. Yoon, Z. Wang, H. Chen and J. Wang, Chem. Rev., 2024, 124, 7007-7044.
Sathe, D.; Zhou, J.; Chen, H.; Su, H. W.; Xie, W.; Hsu, T. G.; Schrage, B. R.; Smith, T.; Ziegler, C. J.; Wang, J. Olefin Metathesis-Based Chemically Recyclable Polymers Enabled by Fused-Ring Monomers. Nat. Chem. 2021, 13, 743-750.
Scholl, M., S. Ding, C. W. Lee and R. H. Grubbs, Org. Lett., 1999, 1, 953-956.
Schrock, R. R. Recent Advances in High Oxidation State Mo and W Imido Alkylidene Chemistry. Chem. Rev. 2009, 109 (8), 3211-3226.
Schrock, R. R.; Murdzek, J. S.; Bazan, G. C.; Robbins, J.; DiMare, M.; O'Regan, M. Synthesis of molybdenum imido alkylidene complexes and some reactions involving acyclic olefins. J. Am. Chem. Soc. 1990, 112 (10), 3875-3886.
Shan, S.-Y., W. Zhang, Q. Cao, Y.-C. Ye, Z. Cai and J.-B. Zhu, Polym. Chem., 2024, 15, 1070-1076.
Shieh, P.; Zhang, W.; Husted, K. E. L.; Kristufek, S. L.; Xiong, B.; Lundberg, D. J.; Lem, J.; Veysset, D.; Sun, Y.; Nelson, K. A.; et al. Cleavable Comonomers Enable Degradable, Recyclable Thermoset Plastics. Nature 2020, 583, 542-547.
Shimizu, T.; Shimizu, K.; Ando, W. Synthesis, structure, and stabilities of trans-1,2-diphenyl-4,4,5,5,6,6-hexamethyl-4,5,6-trisilacy-cloheptene. J. Am. Chem. Soc. 1991, 113 (1), 354-355.
Si, G., and C. Chen, Nat. Synth., 2022, 1, 956-966.
Si, G., Z. Wang, C. Zou and C. Chen, CCS Chem., 2024, 1-10.
Smith, D. W., Jr.; Wagener, K. B. Acyclic diene metathesis (ADMET) polymerization. Design and synthesis of unsaturated poly(carbosiloxanes). Macromolecules 1993, 26 (7), 1633-1642.
Smith, M. L., T. M. McGuire, A. Buchard and C. K. Williams, ACS Catal., 2023, 13, 15770-15778.
Song, Y.; Ma, Z.; Yang, P.; Zhang, X.; Lyu, X.; Jiang, K.; Zhang, W. Single-Molecule Force Spectroscopy Study on Force-Induced Melting in Polymer Single Crystals: The Chain Conformation Matters. Macromolecules 2019, 52, 1327-1333.
Squillacote, M. E.; DeFellipis, J.; Shu, Q. How Stable Is Trans-Cycloheptene?J. Am. Chem. Soc. 2005, 127, 15983-15988.
Tamao, K.; Tsuji, H.; Terada, M.; Asahara, M.; Yamaguchi, S.; Toshimitsu, A. Conformation Control of Oligosilanes Based on Configurationally Constrained Bicyclic Disilane Units. Angew. Chem., Int. Ed. 2000, 39 (18), 3287-3290.
Tang, H., N. Li, G. Li, A. Wang, Y. Cong, G. Xu, X. Wang and T. Zhang, Green Chem., 2019, 21, 2709-2719.
Tilley, T. D. The Coordination Polymerization of Silanes to Polysilanes by a “σ-Bond Metathesis” Mechanism. Implications for Linear Chain Growth. Acc. Chem. Res. 1993, 26, 22-29.
Tsuji, H.; Terada, M.; Toshimitsu, A.; Tamao, K. σσ* Transition in anti,cisoid Alternating Oligosilanes: Clear-Cut Evidence for Suppression of Conjugation Effect by a cisoid Turn. J. Am. Chem. Soc. 2003, 125 (25), 7486-7487.
Ulman, M., T. R. Belderrain and R. H. Grubbs, Tetrahedron Lett., 2000, 41, 4689-4693.
Vidal, F.; Jakle, F. Functional Polymeric Materials Based on Main-Group Elements. Angew. Chem., Int. Ed. 2019, 58 (18), 5846-5870.
Wagener, K. B.; Boncella, J. M.; Nel, J. G. Acyclic diene metathesis (ADMET) polymerization. Macromolecules 1991, 24 (10), 2649-2657.
Wakefield, H. T.; Kevlishvili, I.; Wentz, K. E.; Yao, Y.; Kouznetsova, T. B.; Melvin, S. J.; Ambrosius, E. G.; Herzog-Arbeitman, A.; Siegler, M. A.; Johnson, J. A.; Craig, S. L.; Kulik, H. J.; Klausen, R. S. Synthesis and Ring-Opening Metathesis Polymerization of a Strained trans-Silacycloheptene and Single-Molecule Mechanics of Its Polymer. J. Am. Chem. Soc. 2023, 145 (18), 10187-10196.
Wakefield, H., S. J. Melvin, J. Jiang, I. Kevlishvili, M. A. Siegler, S. L. Craig, H. J. Kulik and R. S. Klausen, Chem. Commun., 2024, 60, 4842-4845.
Waldeck, D. H. Photoisomerization Dynamics of Stilbenes. Chem. Rev. 1991, 91, 415-436.
Walker, R.; Conrad, R. M.; Grubbs, R. H. The Living ROMP of Trans-Cyclooctene. Macromolecules 2009, 42, 599-605.
Wallraff, G. M.; Michl, J.; Boyd, R. H. Conformational Mobility in the Trans-Cycloheptene-Copper(I) Triflate Complex. J. Am. Chem. Soc. 1983, 105, 4550-4555.
Wang, H. S., N. P. Truong, Z. Pei, M. L. Coote and A. Anastasaki, J. Am. Chem. Soc., 2022, 144, 4678-4684.
Wang, K.; Pang, X.; Cui, S. Inherent Stretching Elasticity of a Single Polymer Chain with a Carbon-Carbon Backbone. Langmuir 2013, 29, 4315-4319.
Wang, L.; Zheng, X.; Kouznetsova, T. B.; Yen, T.; Ouchi, T.; Brown, C. L.; Craig, S. L. Mechanochemistry of Cubane. J. Am. Chem. Soc. 2022, 144 (50), 22865-22869.
Wang, M., Y. Li, L. Zheng, T. Hu, M. Yan and C. Wu, Polym. Chem., 2024, 15, 585-608.
Wang, S.; Panyukov, S.; Rubinstein, M.; Craig, S. L. Quantitative Adjustment to the Molecular Energy Parameter in the Lake-Thomas Theory of Polymer Fracture Energy. Macromolecules 2019, 52, 2772-2777.
Wentz, K. E., Y. Yao, I. Kevlishvili, T. B. Kouznetsova, B. A. Mediavilla, H. J. Kulik, S. L. Craig and R. S. Klausen, Macromolecules, 2023, 56, 6776-6782.
Whitfield, R., G. R. Jones, N. P. Truong, L. E. Manring and A. Anastasaki, Angew. Chem., Int. Ed., 2023, 62, e202309116.
Wolf, M. O. Recent Advances in Conjugated Transition Metal-containing Polymers and Materials. J. Inorg. Organomet. Polym. Mater. 2006, 16 (3), 189-199.
Yajima, S.; Hasegawa, Y.; Okamura, K.; Matsuzawa, T. Development of high tensile strength silicon carbide fibre using an organosilicon polymer precursor. Nature 1978, 273 (5663), 525-527.
Young, J. B., R. W. Hughes, A. M. Tamura, L. S. Bailey, K. A. Stewart and B. S. Sumerlin, Chem, 2023, 9, 2669-2682.
Yuan, J., G. J. Giardino and J. Niu, Angew. Chem., Int. Ed., 2021, 60, 24800-24805.
Zhang, D., X. Wang, Z. Zhang and N. Hadjichristidis, Angew. Chem., Int. Ed., 2024, 63, e202402233.
Zhang, X.; Liu, C.; Wang, Z. Force Spectroscopy of Polymers: Studying on Intramolecular and Intermolecular Interactions in Single Molecular Level. Polymer 2008, 49, 3353-3361.
Zhou, J., D. Sathe and J. Wang, J. Am. Chem. Soc., 2022, 144, 928-934.

Although the foregoing subject matter has been described in some detail by way of illustration and example for purposes of clarity of understanding, it will be understood by those skilled in the art that certain changes and modifications can be practiced within the scope of the appended claim.

1. A compound selected from: 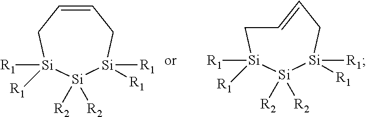
wherein:
R₁ is aryl; and
R₂ is C₁-C₄ alkyl.

2. The compound of claim 1, wherein the compound is selected from: 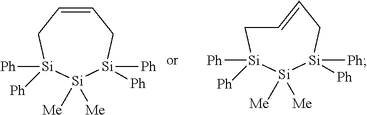
wherein:
Ph is phenyl and Me is methyl.

3. The compound of claim 2, wherein the compound is:

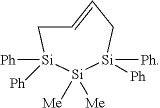 [SMILES: C[Si]1(C)[Si](c2ccccc2)(c2ccccc2)CC=CC[Si]1(c1ccccc1)c1ccccc1]

4. A method for synthesizing a compound of claim 1, the method comprising:
(a) contacting 1,1,1,3,3,3-hexamethyl-2,2-diphenyltrisilane with potassium tert-butoxide in tetrahydrofuran for a first period of time at room temperature and then adding Cl₂SiCH₃ at −78° C. for a second period of time to form 1,1,1,3,3,5,5,5-octamethyl-2,2,4,4-tetraphenylpentasilane;
(b) contacting 1,1,1,3,3,5,5,5-octamethyl-2,2,4,4-tetraphenylpentasilane with potassium tert-butoxide and 18-crown-6 in diethyl ether at room temperature for a third period of time to form a oligosilyldianion having the following chemical structure: 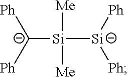 [SMILES: C[Si](C)([C-](c1ccccc1)c1ccccc1)[Si-](c1ccccc1)c1ccccc1]
(c) reacting the oligosilyldianion of step (b) with:
(i) (Z)-1,4-dichlorobutene in toluene at room temperature for a fourth period of time to form: 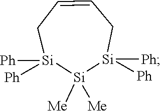 [SMILES: C[Si]1(C)[Si](c2ccccc2)(c2ccccc2)CC=CC[Si]1(c1ccccc1)c1ccccc1]
or
(ii) (E)-1,4-dichlorobutene in toluene at room temperature for a fifth period of time to form:

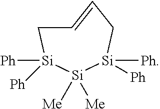 [SMILES: C[Si]1(C)[Si](c2ccccc2)(c2ccccc2)CC=CC[Si]1(c1ccccc1)c1ccccc1]

5. A polymer having the following structure: 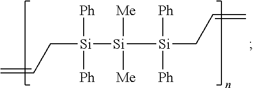
wherein n is an integer from 1 to 10,000.

6. A method for preparing a polymer of claim 5;
the method comprising:
contacting 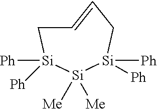 [SMILES: C[Si]1(C)[Si](c2ccccc2)(c2ccccc2)CC=CC[Si]1(c1ccccc1)c1ccccc1]
Grubbs 2nd generation catalyst in dichloromethane at room temperature for a sixth period of time.

7. A polymer having the following structure: 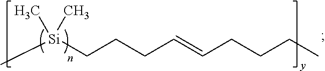
wherein:
n is an integer selected from 1, 2, 3, and 4; and
y is an integer from 1 to 10,000.

8. A method for preparing a polymer of claim 7;
the method comprising:
contacting 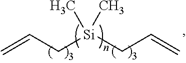
wherein n is an integer selected from 1, 2, 3, and 4, with Schrock's molybdenum catalyst (Mo═CHCMe₂Ph(═N—C₆H₃-i-Pr₂-2,6)(OCMe(CF₃)₂)₂) for a period of time to form a polymer having the following structure:

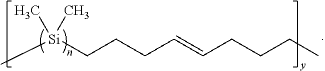

9. A polymer having the following structure: 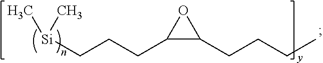
wherein:
n is an integer selected from 1, 2, 3, and 4; and
y is an integer from 1 to 10,000.

10. A method for preparing a polymer of claim 9;
the method comprising:
contacting 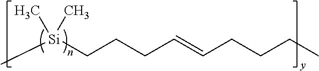
with meta-chloroperoxybenzoic acid in dichloromethane for a period of time to form a polymer having the following structure: [chemical structure]
